(19) United States
(12) Patent Application Publication
(10) Pub. No.: US 2024/0430967 A1
(43) Pub. Date: Dec. 26, 2024

(54) INDICATION OF INFORMATION AVAILABILITY IN WIRELESS COMMUNICATIONS

(71) Applicant: LG ELECTRONICS INC., Seoul (KR)

(72) Inventors: Siyoung CHOI, Seoul (KR); Sunghoon JUNG, Seoul (KR)

(73) Assignee: LG ELECTRONICS INC., Seoul (KR)

(21) Appl. No.: 18/708,064

(22) PCT Filed: Jan. 9, 2023
(86) PCT No.: PCT/KR2023/000389

§ 371 Date: May 7, 2024

(30) Foreign Application Priority Data
Jan. 10, 2022 (KR) 10-2022-0003584

(51) Int. Cl. H04W 76/18; H04W 76/19

(52) U.S. Cl. CPC H04W 76/18; H04W 76/19

(57) ABSTRACT

The present disclosure relates to an indication of information availability in wireless communications. According to an embodiment of the present disclosure, a method performed by a user equipment (UE) in a wireless communication system comprises: obtaining report information including one or more information elements (IEs) with a first version and one or more IEs with a second version, wherein the first version is an earlier version than the second version, and the second version is a latest version of radio protocol; and transmitting, to a network, a message for informing an availability of the report information, wherein the message excludes information for the first version, and includes information for the second version.

### CROSS-REFERENCE TO RELATED APPLICATION(S)

This application is the National Stage filing under 35 U.S.C. 371 of International Application No. PCT/KR2023/000389, filed on Jan. 9, 2023, which claims the benefit of earlier filing date and right of priority to Korean Application No. 10-2022-0003584, filed on Jan. 10, 2022, the contents of which are all hereby incorporated by reference herein in their entireties.

### TECHNICAL FIELD

The present disclosure relates to an indication of information availability in wireless communications.

### BACKGROUND

3rd generation partnership project (3GPP) long-term evolution (LTE) is a technology for enabling high-speed packet communications. Many schemes have been proposed for the LTE objective including those that aim to reduce user and provider costs, improve service quality, and expand and improve coverage and system capacity. The 3GPP LTE requires reduced cost per bit, increased service availability, flexible use of a frequency band, a simple structure, an open interface, and adequate power consumption of a terminal as an upper-level requirement.

Work has started in international telecommunication union (ITU) and 3GPP to develop requirements and specifications for new radio (NR) systems. 3GPP has to identify and develop the technology components needed for successfully standardizing the new RAT timely satisfying both the urgent market needs, and the more long-term requirements set forth by the ITU radio communication sector (ITU-R) international mobile telecommunications (IMT)-2020 process. Further, the NR should be able to use any spectrum band ranging at least up to 100 GHz that may be made available for wireless communications even in a more distant future.

The NR targets a single technical framework addressing all usage scenarios, requirements and deployment scenarios including enhanced mobile broadband (eMBB), massive machine-type-communications (mMTC), ultra-reliable and low latency communications (URLLC), etc. The NR shall be inherently forward compatible.

In wireless communications, a user equipment (UE) may indicate to a network that which information is available at the UE. The network may request UE information to the UE while taking the indication of information availability into account. When requested, the UE may transmit UE information including the information available at the UE, to the network.

### SUMMARY

An aspect of the present disclosure is to provide method and apparatus for indication of information availability in wireless communications.

According to an embodiment of the present disclosure, a method performed by a user equipment (UE) in a wireless communication system comprises: obtaining report information including one or more information elements (IEs) with a first version and one or more IEs with a second version, wherein the first version is an earlier version than the second version, and the second version is a latest version of radio protocol; and transmitting, to a network, a message for informing an availability of the report information, wherein the message excludes information for the first version, and includes information for the second version.

According to an embodiment of the present disclosure, a method performed by a network node adapted to operate in a wireless communication system comprises: receiving, from a user equipment (UE), a message for informing an availability of report information, wherein the message excludes information for a first version of one or more information elements (IEs) in the report information and includes information for a second version of one or more IEs in the report information, and wherein the first version is an earlier version than the second version, and the second version is a latest version of radio protocol; and transmitting, to the UE, a message for requesting the report information based on whether the second version is supported by the network node.

According to an embodiment of the present disclosure, apparatuses implementing the above methods are described.

The present disclosure can have various advantageous effects.

For example, the reporting data loss problem incurred by the limitation of interpretation capability of NW (e.g. eNB, gNB, etc.) can be prevented. In doing so, NW can collect data from UEs for SON without data loss, which results in mobility robustness optimization (MRO) and/or mobility load balancing (MLB) enhancements.

Advantageous effects which can be obtained through specific embodiments of the present disclosure are not limited to the advantageous effects listed above. For example, there may be a variety of technical effects that a person having ordinary skill in the related art can understand and/or derive from the present disclosure. Accordingly, the specific effects of the present disclosure are not limited to those explicitly described herein, but may include various effects that may be understood or derived from the technical features of the present disclosure.

### BRIEF DESCRIPTION OF DRAWINGS

FIG. 1 shows an example of a communication system to which implementations of the present disclosure is applied.

FIG. 2 shows an example of wireless devices to which implementations of the present disclosure is applied.

FIG. 3 shows an example of a wireless device to which implementations of the present disclosure is applied.

FIG. 4 shows another example of wireless devices to which implementations of the present disclosure is applied.

FIG. 5 shows an example of UE to which implementations of the present disclosure is applied.

FIGS. 6 and 7 show an example of protocol stacks in a 3GPP based wireless communication system to which implementations of the present disclosure is applied.

FIG. 8 shows a frame structure in a 3GPP based wireless communication system to which implementations of the present disclosure is applied.

FIG. 9 shows a data flow example in the 3GPP NR system to which implementations of the present disclosure is applied.

FIG. 10 shows an example of a conditional mobility procedure to which technical features of the present disclosure can be applied.

FIG. 11 shows an example of an RRC re-establishment procedure according to an embodiment of the present disclosure.

FIG. 12 shows an example of a UE information procedure according to an embodiment of the present disclosure.

FIG. 13 shows an example of a method performed by a UE according to an embodiment of the present disclosure.

FIG. 14 shows an example of a method performed by a network node according to an embodiment of the present disclosure.

FIG. 15 shows an example of a procedure for signalling an availability indicator according to an embodiment of the present disclosure.

FIG. 16 shows an example of a procedure for signalling an availability indicator and one or more requesting indicators according to an embodiment of the present disclosure.

### DETAILED DESCRIPTION

The following techniques, apparatuses, and systems may be applied to a variety of wireless multiple access systems. Examples of the multiple access systems include a code division multiple access (CDMA) system, a frequency division multiple access (FDMA) system, a time division multiple access (TDMA) system, an orthogonal frequency division multiple access (OFDMA) system, a single carrier frequency division multiple access (SC-FDMA) system, and a multicarrier frequency division multiple access (MC-FDMA) system. CDMA may be embodied through radio technology such as universal terrestrial radio access (UTRA) or CDMA2000. TDMA may be embodied through radio technology such as global system for mobile communications (GSM), general packet radio service (GPRS), or enhanced data rates for GSM evolution (EDGE). OFDMA may be embodied through radio technology such as institute of electrical and electronics engineers (IEEE) 802.11 (Wi-Fi), IEEE 802.16 (WiMAX), IEEE 802.20, or evolved UTRA (E-UTRA). UTRA is a part of a universal mobile telecommunications system (UMTS). 3rd generation partnership project (3GPP) long term evolution (LTE) is a part of evolved UMTS (E-UMTS) using E-UTRA. 3GPP LTE employs OFDMA in DL and SC-FDMA in UL. LTE-advanced (LTE-A) is an evolved version of 3GPP LTE.

For convenience of description, implementations of the present disclosure are mainly described in regards to a 3GPP based wireless communication system. However, the technical features of the present disclosure are not limited thereto. For example, although the following detailed description is given based on a mobile communication system corresponding to a 3GPP based wireless communication system, aspects of the present disclosure that are not limited to 3GPP based wireless communication system are applicable to other mobile communication systems.

For terms and technologies which are not specifically described among the terms of and technologies employed in the present disclosure, the wireless communication standard documents published before the present disclosure may be referenced.

In the present disclosure, “A or B” may mean “only A”, “only B”, or “both A and B”. In other words, “A or B” in the present disclosure may be interpreted as “A and/or B”. For example. “A. B or C” in the present disclosure may mean “only A”, “only B”, “only C”, or “any combination of A, B and C”.

In the present disclosure, slash (/) or comma (,) may mean “and/or”. For example. “A/B” may mean “A and/or B”. Accordingly. “A/B” may mean “only A”, “only B”, or “both A and B”. For example, “A, B, C” may mean “A, B or C”.

In the present disclosure, “at least one of A and B” may mean “only A”, “only B” or “both A and B”. In addition, the expression “at least one of A or B” or “at least one of A and/or B” in the present disclosure may be interpreted as same as “at least one of A and B”.

In addition, in the present disclosure, “at least one of A, B and C” may mean “only A”, “only B”, “only C”, or “any combination of A, B and C”. In addition, “at least one of A, B or C” or “at least one of A, B and/or C” may mean “at least one of A, B and C”.

Also, parentheses used in the present disclosure may mean “for example”. In detail, when it is shown as “control information (PDCCH)”, “PDCCH” may be proposed as an example of “control information”. In other words, “control information” in the present disclosure is not limited to “PDCCH”, and “PDCCH” may be proposed as an example of “control information”. In addition, even when shown as “control information (i.e., PDCCH)”, “PDCCH” may be proposed as an example of “control information”.

Technical features that are separately described in one drawing in the present disclosure may be implemented separately or simultaneously.

Throughout the disclosure, the terms ‘radio access network (RAN) node’, ‘base station’, ‘eNB’, ‘gNB’ and ‘cell’ may be used interchangeably. Further, a UE may be a kind of a wireless device, and throughout the disclosure, the terms ‘UE’ and ‘wireless device’ may be used interchangeably.

Throughout the disclosure, the terms ‘cell quality’, ‘signal strength’, ‘signal quality’, ‘channel state’, ‘channel quality’, ‘channel state/reference signal received power (RSRP)’ and ‘reference signal received quality (RSRQ)’ may be used interchangeably.

Although not limited thereto, various descriptions, functions, procedures, suggestions, methods and/or operational flowcharts of the present disclosure disclosed herein can be applied to various fields requiring wireless communication and/or connection (e.g., 5G) between devices.

Hereinafter, the present disclosure will be described in more detail with reference to drawings. The same reference numerals in the following drawings and/or descriptions may refer to the same and/or corresponding hardware blocks, software blocks, and/or functional blocks unless otherwise indicated.

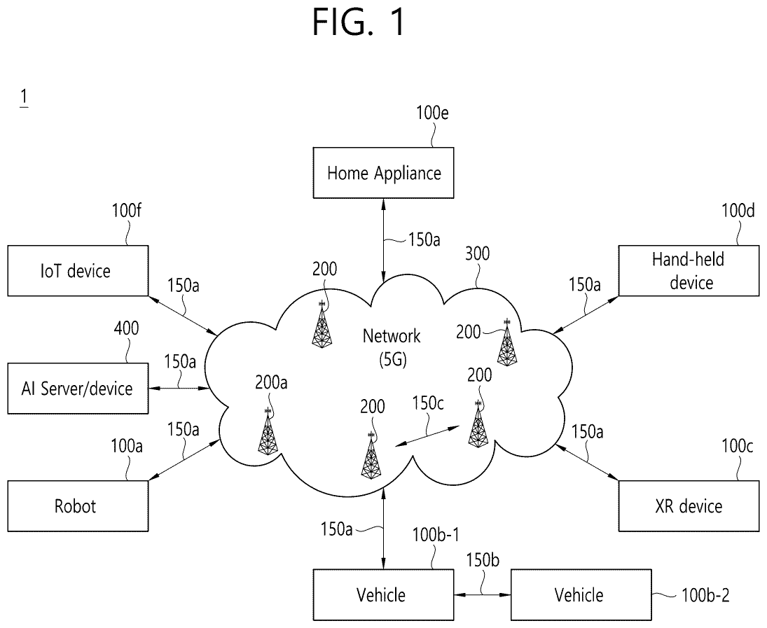

FIG. 1 shows an example of a communication system to which implementations of the present disclosure is applied.

The 5G usage scenarios shown in FIG. 1 are only exemplary, and the technical features of the present disclosure can be applied to other 5G usage scenarios which are not shown in FIG. 1.

Three main requirement categories for 5G include (1) a category of enhanced mobile broadband (eMBB), (2) a category of massive machine type communication (mMTC), and (3) a category of ultra-reliable and low latency communications (URLLC).

Partial use cases may require a plurality of categories for optimization and other use cases may focus only upon one key performance indicator (KPI). 5G supports such various use cases using a flexible and reliable method.

eMBB far surpasses basic mobile Internet access and covers abundant bidirectional work and media and entertainment applications in cloud and augmented reality. Data is one of 5G core motive forces and, in a 5G era, a dedicated voice service may not be provided for the first time. In 5G, it is expected that voice will be simply processed as an application program using data connection provided by a communication system. Main causes for increased traffic volume are due to an increase in the size of content and an increase in the number of applications requiring high data transmission rate. A streaming service (of audio and video), conversational video, and mobile Internet access will be more widely used as more devices are connected to the Internet. These many application programs require connectivity of an always turned-on state in order to push real-time information and alarm for users. Cloud storage and applications are rapidly increasing in a mobile communication platform and may be applied to both work and entertainment. The cloud storage is a special use case which accelerates growth of uplink data transmission rate, 5G is also used for remote work of cloud. When a tactile interface is used, 5G demands much lower end-to-end latency to maintain user good experience. Entertainment, for example, cloud gaming and video streaming, is another core element which increases demand for mobile broadband capability. Entertainment is essential for a smartphone and a tablet in any place including high mobility environments such as a train, a vehicle, and an airplane. Other use cases are augmented reality for entertainment and information search. In this case, the augmented reality requires very low latency and instantaneous data volume.

In addition, one of the most expected 5G use cases relates a function capable of smoothly connecting embedded sensors in all fields, i.e., mMTC. It is expected that the number of potential Internet-of-things (IoT) devices will reach 204 hundred million up to the year of 2020. An industrial IoT is one of categories of performing a main role enabling a smart city, asset tracking, smart utility, agriculture, and security infrastructure through 5G.

URLLC includes a new service that will change industry through remote control of main infrastructure and an ultra-reliable/available low-latency link such as a self-driving vehicle. A level of reliability and latency is essential to control a smart grid, automatize industry, achieve robotics, and control and adjust a drone.

5G is a means of providing streaming evaluated as a few hundred megabits per second to gigabits per second and may complement fiber-to-the-home (FTTH) and cable-based broadband (or DOCSIS). Such fast speed is needed to deliver TV in resolution of 4K or more (6K, 8K, and more), as well as virtual reality and augmented reality. Virtual reality (VR) and augmented reality (AR) applications include almost immersive sports games. A specific application program may require a special network configuration. For example, for VR games, gaming companies need to incorporate a core server into an edge network server of a network operator in order to minimize latency.

Automotive is expected to be a new important motivated force in 5G together with many use cases for mobile communication for vehicles. For example, entertainment for passengers requires high simultaneous capacity and mobile broadband with high mobility. This is because future users continue to expect connection of high quality regardless of their locations and speeds. Another use case of an automotive field is an AR dashboard. The AR dashboard causes a driver to identify an object in the dark in addition to an object seen from a front window and displays a distance from the object and a movement of the object by overlapping information talking to the driver. In the future, a wireless module enables communication between vehicles, information exchange between a vehicle and supporting infrastructure, and information exchange between a vehicle and other connected devices (e.g., devices accompanied by a pedestrian). A safety system guides alternative courses of a behavior so that a driver may drive more safely drive, thereby lowering the danger of an accident. The next stage will be a remotely controlled or self-driven vehicle. This requires very high reliability and very fast communication between different self-driven vehicles and between a vehicle and infrastructure. In the future, a self-driven vehicle will perform all driving activities and a driver will focus only upon abnormal traffic that the vehicle cannot identify. Technical requirements of a self-driven vehicle demand ultra-low latency and ultra-high reliability so that traffic safety is increased to a level that cannot be achieved by human being.

A smart city and a smart home/building mentioned as a smart society will be embedded in a high-density wireless sensor network. A distributed network of an intelligent sensor will identify conditions for costs and energy-efficient maintenance of a city or a home. Similar configurations may be performed for respective households. All of temperature sensors, window and heating controllers, burglar alarms, and home appliances are wirelessly connected, Many of these sensors are typically low in data transmission rate, power, and cost. However, real-time HD video may be demanded by a specific type of device to perform monitoring.

Consumption and distribution of energy including heat or gas is distributed at a higher level so that automated control of the distribution sensor network is demanded. The smart grid collects information and connects the sensors to each other using digital information and communication technology so as to act according to the collected information. Since this information may include behaviors of a supply company and a consumer, the smart grid may improve distribution of fuels such as electricity by a method having efficiency, reliability, economic feasibility, production sustainability, and automation. The smart grid may also be regarded as another sensor network having low latency.

Mission critical application (e.g., e-health) is one of 5G use scenarios. A health part contains many application programs capable of enjoying benefit of mobile communication. A communication system may support remote treatment that provides clinical treatment in a faraway place. Remote treatment may aid in reducing a barrier against distance and improve access to medical services that cannot be continuously available in a faraway rural area. Remote treatment is also used to perform important treatment and save lives in an emergency situation. The wireless sensor network based on mobile communication may provide remote monitoring and sensors for parameters such as heart rate and blood pressure.

Wireless and mobile communication gradually becomes important in the field of an industrial application. Wiring is high in installation and maintenance cost. Therefore, a possibility of replacing a cable with reconstructible wireless links is an attractive opportunity in many industrial fields. However, in order to achieve this replacement, it is necessary for wireless connection to be established with latency, reliability, and capacity similar to those of the cable and management of wireless connection needs to be simplified. Low latency and a very low error probability are new requirements when connection to 5G is needed.

Logistics and freight tracking are important use cases for mobile communication that enables inventory and package tracking anywhere using a location-based information system. The use cases of logistics and freight typically demand low data rate but require location information with a wide range and reliability.

Referring to FIG. 1, the communication system 1 includes wireless devices 100a to 100f, base stations (BSs) 200, and a network 300. Although FIG. 1 illustrates a 5G network as an example of the network of the communication system 1, the implementations of the present disclosure are not limited to the 5G system, and can be applied to the future communication system beyond the 5G system.

The BSs 200 and the network 300 may be implemented as wireless devices and a specific wireless device may operate as a BS/network node with respect to other wireless devices.

The wireless devices 100a to 100f represent devices performing communication using radio access technology (RAT) (e.g., 5G new RAT (NR)) or LTE) and may be referred to as communication/radio/5G devices. The wireless devices 100a to 100f may include, without being limited to, a robot 100a, vehicles 100b-1 and 100b-2, an extended reality (XR) device 100c. a hand-held device 100d. a home appliance 100e, an IoT device 100f, and an artificial intelligence (AI) device/server 400. For example, the vehicles may include a vehicle having a wireless communication function, an autonomous driving vehicle, and a vehicle capable of performing communication between vehicles. The vehicles may include an unmanned aerial vehicle (UAV) (e.g., a drone). The XR device may include an AR/VR/Mixed Reality (MR) device and may be implemented in the form of a head-mounted device (HMD), a head-up display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter.

In the present disclosure, the wireless devices 100a to 100f may be called user equipments (UEs). A UE may include, for example, a cellular phone, a smartphone, a laptop computer, a digital broadcast terminal, a personal digital assistant (PDA), a portable multimedia player (PMP), a navigation system, a slate personal computer (PC), a tablet PC, an ultrabook, a vehicle, a vehicle having an autonomous traveling function, a connected car, an UAV, an AI module, a robot, an AR device, a VR device, an MR device, a hologram device, a public safety device, an MTC device, an IoT device, a medical device, a FinTech device (or a financial device), a security device, a weather/environment device, a device related to a 5G service, or a device related to a fourth industrial revolution field.

The UAV may be, for example, an aircraft aviated by a wireless control signal without a human being onboard.

The VR device may include, for example, a device for implementing an object or a background of the virtual world. The AR device may include, for example, a device implemented by connecting an object or a background of the virtual world to an object or a background of the real world. The MR device may include, for example, a device implemented by merging an object or a background of the virtual world into an object or a background of the real world. The hologram device may include, for example, a device for implementing a stereoscopic image of 360 degrees by recording and reproducing stereoscopic information, using an interference phenomenon of light generated when two laser lights called holography meet.

The public safety device may include, for example, an image relay device or an image device that is wearable on the body of a user.

The MTC device and the IoT device may be, for example, devices that do not require direct human intervention or manipulation. For example, the MTC device and the IoT device may include smartmeters, vending machines, thermometers, smartbulbs, door locks, or various sensors.

Here, the radio communication technologies implemented in the wireless devices in the present disclosure may include narrowband internet-of-things (NB-IoT) technology for low-power communication as well as LTE, NR and 6G. For example, NB-IoT technology may be an example of low power wide area network (LPWAN) technology, may be implemented in specifications such as LTE Cat NB1 and/or LTE Cat NB2, and may not be limited to the above-mentioned names. Additionally and/or alternatively, the radio communication technologies implemented in the wireless devices in the present disclosure may communicate based on LTE-M technology. For example, LTE-M technology may be an example of LPWAN technology and be called by various names such as enhanced machine type communication (eMTC). For example, LTE-M technology may be implemented in at least one of the various specifications, such as 1) LTE Cat 0, 2) LTE Cat M1, 3) LTE Cat M2, 4) LTE non-bandwidth limited (non-BL), 5) LTE-MTC, 6) LTE Machine Type Communication, and/or 7) LTE M, and may not be limited to the above-mentioned names. Additionally and/or alternatively, the radio communication technologies implemented in the wireless devices in the present disclosure may include at least one of ZigBee, Bluetooth, and/or LPWAN which take into account low-power communication, and may not be limited to the above-mentioned names. For example, ZigBee technology may generate personal area networks (PANs) associated with small/low-power digital communication based on various specifications such as IEEE 802.15.4 and may be called various names.

The medical device may be, for example, a device used for the purpose of diagnosing, treating, relieving, curing, or preventing disease. For example, the medical device may be a device used for the purpose of diagnosing, treating, relieving, or correcting injury or impairment. For example, the medical device may be a device used for the purpose of inspecting, replacing, or modifying a structure or a function. For example, the medical device may be a device used for the purpose of adjusting pregnancy. For example, the medical device may include a device for treatment, a device for operation, a device for (in vitro) diagnosis, a hearing aid, or a device for procedure.

The security device may be, for example, a device installed to prevent a danger that may arise and to maintain safety. For example, the security device may be a camera, a closed-circuit TV (CCTV), a recorder, or a black box.

The FinTech device may be, for example, a device capable of providing a financial service such as mobile payment. For example, the FinTech device may include a payment device or a point of sales (POS) system.

The weather/environment device may include, for example, a device for monitoring or predicting a weather/environment.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, a 5G (e.g., NR) network, and a beyond-5G network. Although the wireless devices 100a to 100f may communicate with each other through the BSs 200/network 300, the wireless devices 100a to 100f may perform direct communication (e.g., sidelink communication) with each other without passing through the BSs 200/network 300. For example, the vehicles 100b-1 and 100b-2 may perform direct communication (e.g., vehicle-to-vehicle (V2V)/vehicle-to-everything (V2X) communication). The IoT device (e.g., a sensor) may perform direct communication with other IoT devices (e.g., sensors) or other wireless devices 100a to 100f.

Wireless communication/connections 150a, 150b and 150c may be established between the wireless devices 100a to 100f and/or between wireless device 100a to 100f and BS 200 and/or between BSs 200. Herein, the wireless communication/connections may be established through various RATs (e.g., 5G NR) such as uplink/downlink communication 150a, sidelink communication (or device-to-device (D2D) communication) 150b, inter-base station communication 150c (e.g., relay, integrated access and backhaul (IAB)), etc. The wireless devices 100a to 100f and the BSs 200/the wireless devices 100a to 100f may transmit/receive radio signals to/from each other through the wireless communication/connections 150a, 150b and 150c. For example, the wireless communication/connections 150a, 150b and 150c may transmit/receive signals through various physical channels. To this end, at least a part of various configuration information configuring processes, various signal processing processes (e.g., channel encoding/decoding, modulation/demodulation, and resource mapping/de-mapping), and resource allocating processes, for transmitting/receiving radio signals, may be performed based on the various proposals of the present disclosure.

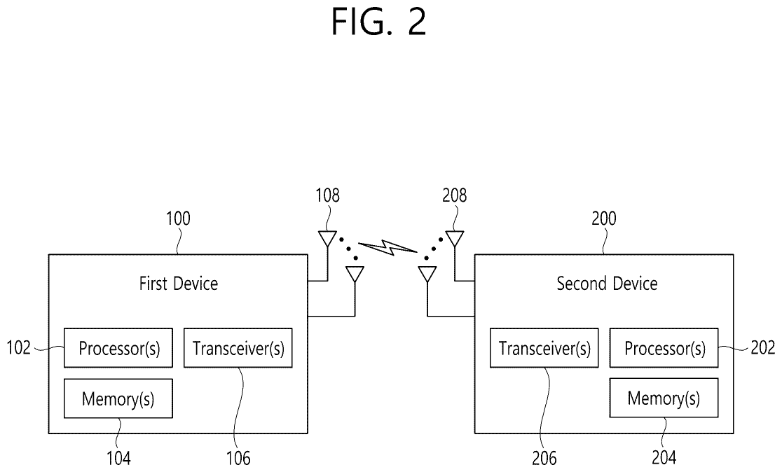

FIG. 2 shows an example of wireless devices to which implementations of the present disclosure is applied.

Referring to FIG. 2, a first wireless device 100 and a second wireless device 200 may transmit/receive radio signals to/from an external device through a variety of RATs (e.g., LTE and NR). In FIG. 2, {the first wireless device 100 and the second wireless device 200} may correspond to at least one of {the wireless device 100a to 100f and the BS 200}, {the wireless device 100a to 100f and the wireless device 100a to 100f} and/or {the BS 200 and the BS 200} of FIG. 1.

The first wireless device 100 may include one or more processors 102 and one or more memories 104 and additionally further include one or more transceivers 106 and/or one or more antennas 108. The processor(s) 102 may control the memory(s) 104 and/or the transceiver(s) 106 and may be configured to/adapted to implement the descriptions, functions, procedures, suggestions, methods and/or operational flowcharts described in the present disclosure. For example, the processor(s) 102 may process information within the memory(s) 104 to generate first information/signals and then transmit radio signals including the first information/signals through the transceiver(s) 106. The processor(s) 102 may receive radio signals including second information/signals through the transceiver(s) 106 and then store information obtained by processing the second information/signals in the memory(s) 104. The memory(s) 104 may be connected to the processor(s) 102 and may store a variety of information related to operations of the processor(s) 102. For example, the memory(s) 104 may store software code including commands for performing a part or the entirety of processes controlled by the processor(s) 102 or for performing the descriptions, functions, procedures, suggestions, methods and/or operational flowcharts described in the present disclosure. Herein, the processor(s) 102 and the memory(s) 104 may be a part of a communication modem/circuit/chip designed to implement RAT (e.g., LTE or NR). The transceiver(s) 106 may be connected to the processor(s) 102 and transmit and/or receive radio signals through one or more antennas 108. Each of the transceiver(s) 106 may include a transmitter and/or a receiver. The transceiver(s) 106 may be interchangeably used with radio frequency (RF) unit(s). In the present disclosure, the first wireless device 100 may represent a communication modem/circuit/chip.

The second wireless device 200 may include one or more processors 202 and one or more memories 204 and additionally further include one or more transceivers 206 and/or one or more antennas 208. The processor(s) 202 may control the memory(s) 204 and/or the transceiver(s) 206 and may be configured to/adapted to implement the descriptions, functions, procedures, suggestions, methods and/or operational flowcharts described in the present disclosure. For example, the processor(s) 202 may process information within the memory(s) 204 to generate third information/signals and then transmit radio signals including the third information/signals through the transceiver(s) 206. The processor(s) 202 may receive radio signals including fourth information/signals through the transceiver(s) 106 and then store information obtained by processing the fourth information/signals in the memory(s) 204. The memory(s) 204 may be connected to the processor(s) 202 and may store a variety of information related to operations of the processor(s) 202. For example, the memory(s) 204 may store software code including commands for performing a part or the entirety of processes controlled by the processor(s) 202 or for performing the descriptions, functions, procedures, suggestions, methods and/or operational flowcharts described in the present disclosure. Herein, the processor(s) 202 and the memory(s) 204 may be a part of a communication modem/circuit/chip designed to implement RAT (e.g., LTE or NR). The transceiver(s) 206 may be connected to the processor(s) 202 and transmit and/or receive radio signals through one or more antennas 208. Each of the transceiver(s) 206 may include a transmitter and/or a receiver. The transceiver(s) 206 may be interchangeably used with RF unit(s). In the present disclosure, the second wireless device 200 may represent a communication modem/circuit/chip.

Hereinafter, hardware elements of the wireless devices 100 and 200 will be described more specifically. One or more protocol layers may be implemented by, without being limited to, one or more processors 102 and 202. For example. the one or more processors 102 and 202 may implement one or more layers (e.g., functional layers such as physical (PHY) layer, media access control (MAC) layer, radio link control (RLC) layer, packet data convergence protocol (PDCP) layer, radio resource control (RRC) layer, and service data adaptation protocol (SDAP) layer). The one or more processors 102 and 202 may generate one or more protocol data units (PDUs) and/or one or more service data unit (SDUs) according to the descriptions, functions, procedures, suggestions, methods and/or operational flowcharts disclosed in the present disclosure. The one or more processors 102 and 202 may generate messages, control information, data, or information according to the descriptions, functions, procedures, suggestions, methods and/or operational flowcharts disclosed in the present disclosure. The one or more processors 102 and 202 may generate signals (e.g., baseband signals) including PDUs, SDUs, messages, control information, data, or information according to the descriptions, functions, procedures, suggestions, methods and/or operational flowcharts disclosed in the present disclosure and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, suggestions, methods and/or operational flowcharts disclosed in the present disclosure.

The one or more processors 102 and 202 may be referred to as controllers, microcontrollers, microprocessors, or microcomputers. The one or more processors 102 and 202 may be implemented by hardware, firmware, software, or a combination thereof. As an example, one or more application specific integrated circuits (ASICs), one or more digital signal processors (DSPs), one or more digital signal processing devices (DSPDs), one or more programmable logic devices (PLDs), or one or more field programmable gate arrays (FPGAs) may be included in the one or more processors 102 and 202. descriptions, functions, procedures, suggestions, methods and/or operational flowcharts disclosed in the present disclosure may be implemented using firmware or software and the firmware or software may be configured to/adapted to include the modules, procedures, or functions. Firmware or software configured to/adapted to perform the descriptions, functions, procedures, suggestions, methods and/or operational flowcharts disclosed in the present disclosure may be included in the one or more processors 102 and 202 or stored in the one or more memories 104 and 204 so as to be driven by the one or more processors 102 and 202. The descriptions, functions, procedures, suggestions, methods and/or operational flowcharts disclosed in the present disclosure may be implemented using firmware or software in the form of code, commands, and/or a set of commands.

The one or more memories 104 and 204 may be connected to the one or more processors 102 and 202 and store various types of data, signals, messages, information, programs, code, instructions, and/or commands. The one or more memories 104 and 204 may be configured by read-only memories (ROMs), random access memories (RAMs), electrically erasable programmable read-only memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the descriptions, functions, procedures, suggestions, methods and/or operational flowcharts disclosed in the present disclosure, to one or more other devices. The one or more transceivers 106 and 206 may receive user data, control information, and/or radio signals/channels, mentioned in the descriptions, functions, procedures, suggestions, methods and/or operational flowcharts disclosed in the present disclosure, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices.

The one or more transceivers 106 and 206 may be connected to the one or more antennas 108 and 208 and the one or more transceivers 106 and 206 may be configured to/adapted to transmit and receive user data, control information, and/or radio signals/channels, mentioned in the descriptions, functions, procedures, suggestions, methods and/or operational flowcharts disclosed in the present disclosure, through the one or more antennas 108 and 208. In the present disclosure, the one or more antennas may be a plurality of physical antennas or a plurality of logical antennas (e.g., antenna ports).

The one or more transceivers 106 and 206 may convert received radio signals/channels, etc., from RF band signals into baseband signals in order to process received user data, control information, radio signals/channels, etc., using the one or more processors 102 and 202. The one or more transceivers 106 and 206 may convert the user data, control information, radio signals/channels, etc., processed using the one or more processors 102 and 202 from the base band signals into the RF band signals. To this end, the one or more transceivers 106 and 206 may include (analog) oscillators and/or filters. For example, the transceivers 106 and 206 can up-convert OFDM baseband signals to a carrier frequency by their (analog) oscillators and/or filters under the control of the processors 102 and 202 and transmit the up-converted OFDM signals at the carrier frequency. The transceivers 106 and 206 may receive OFDM signals at a carrier frequency and down-convert the OFDM signals into OFDM baseband signals by their (analog) oscillators and/or filters under the control of the transceivers 102 and 202.

In the implementations of the present disclosure, a UE may operate as a transmitting device in uplink (UL) and as a receiving device in downlink (DL). In the implementations of the present disclosure, a BS may operate as a receiving device in UL and as a transmitting device in DL. Hereinafter, for convenience of description, it is mainly assumed that the first wireless device 100 acts as the UE, and the second wireless device 200 acts as the BS. For example, the processor(s) 102 connected to, mounted on or launched in the first wireless device 100 may be configured to/adapted to perform the UE behavior according to an implementation of the present disclosure or control the transceiver(s) 106 to perform the UE behavior according to an implementation of the present disclosure. The processor(s) 202 connected to, mounted on or launched in the second wireless device 200 may be configured to/adapted to perform the BS behavior according to an implementation of the present disclosure or control the transceiver(s) 206 to perform the BS behavior according to an implementation of the present disclosure.

In the present disclosure, a BS is also referred to as a node B (NB), an eNode B (eNB), or a gNB.

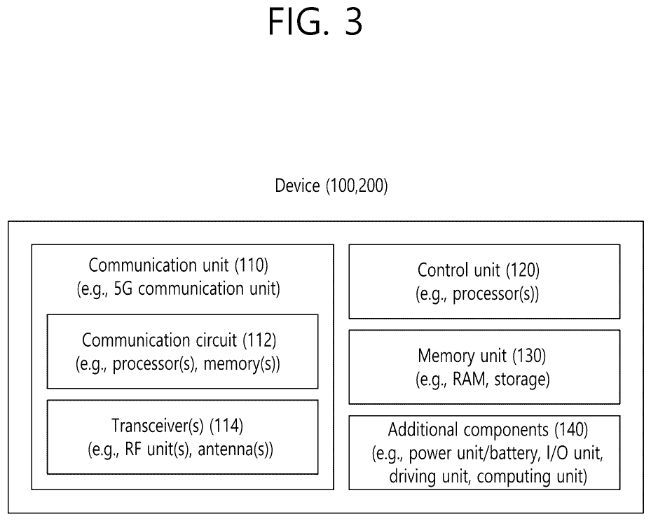

FIG. 3 shows an example of a wireless device to which implementations of the present disclosure is applied.

The wireless device may be implemented in various forms according to a use-case/service (refer to FIG. 1).

Referring to FIG. 3, wireless devices 100 and 200 may correspond to the wireless devices 100 and 200 of FIG. 2 and may be configured by various elements, components, units/portions, and/or modules. For example, each of the wireless devices 100 and 200 may include a communication unit 110, a control unit 120, a memory unit 130, and additional components 140. The communication unit 110 may include a communication circuit 112 and transceiver(s) 114. For example, the communication circuit 112 may include the one or more processors 102 and 202 of FIG. 2 and/or the one or more memories 104 and 204 of FIG. 2. For example, the transceiver(s) 114 may include the one or more transceivers 106 and 206 of FIG. 2 and/or the one or more antennas 108 and 208 of FIG. 2. The control unit 120 is electrically connected to the communication unit 110, the memory 130, and the additional components 140 and controls overall operation of each of the wireless devices 100 and 200. For example, the control unit 120 may control an electric/mechanical operation of each of the wireless devices 100 and 200 based on programs/code/commands/information stored in the memory unit 130. The control unit 120 may transmit the information stored in the memory unit 130 to the exterior (e.g., other communication devices) via the communication unit 110 through a wireless/wired interface or store, in the memory unit 130, information received through the wireless/wired interface from the exterior (e.g., other communication devices) via the communication unit 110.

The additional components 140 may be variously configured according to types of the wireless devices 100 and 200. For example, the additional components 140 may include at least one of a power unit/battery, input/output (I/O) unit (e.g., audio I/O port, video I/O port), a driving unit, and a computing unit. The wireless devices 100 and 200 may be implemented in the form of, without being limited to, the robot (100a of FIG. 1), the vehicles (100b-1 and 100b-2 of FIG. 1), the XR device (100c of FIG. 1), the hand-held device (100d of FIG. 1), the home appliance (100e of FIG. 1), the IoT device (100f of FIG. 1), a digital broadcast terminal, a hologram device, a public safety device, an MTC device, a medicine device, a FinTech device (or a finance device), a security device, a climate/environment device, the AI server/device (400 of FIG. 1), the BSs (200 of FIG. 1), a network node, etc. The wireless devices 100 and 200 may be used in a mobile or fixed place according to a use-example/service.

In FIG. 3, the entirety of the various elements, components, units/portions, and/or modules in the wireless devices 100 and 200 may be connected to each other through a wired interface or at least a part thereof may be wirelessly connected through the communication unit 110. For example, in each of the wireless devices 100 and 200, the control unit 120 and the communication unit 110 may be connected by wire and the control unit 120 and first units (e.g., 130 and 140) may be wirelessly connected through the communication unit 110. Each element, component, unit/portion, and/or module within the wireless devices 100 and 200 may further include one or more elements. For example, the control unit 120 may be configured by a set of one or more processors. As an example, the control unit 120 may be configured by a set of a communication control processor, an application processor (AP), an electronic control unit (ECU), a graphical processing unit, and a memory control processor. As another example, the memory 130 may be configured by a RAM, a DRAM, a ROM, a flash memory, a volatile memory, a non-volatile memory, and/or a combination thereof.

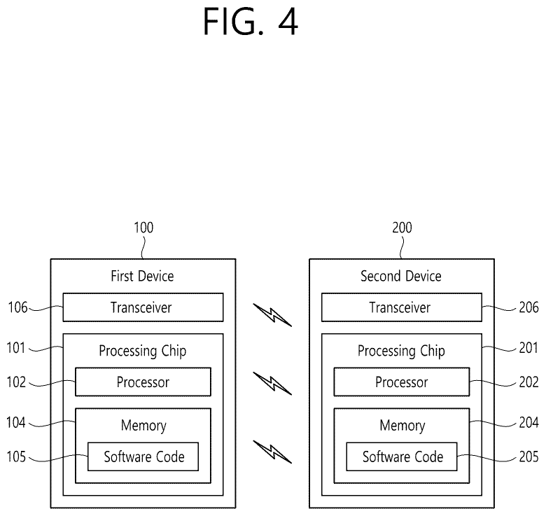

FIG. 4 shows another example of wireless devices to which implementations of the present disclosure is applied.

Referring to FIG. 4, wireless devices 100 and 200 may correspond to the wireless devices 100 and 200 of FIG. 2 and may be configured by various elements, components, units/portions, and/or modules.

The first wireless device 100 may include at least one transceiver, such as a transceiver 106, and at least one processing chip, such as a processing chip 101. The processing chip 101 may include at least one processor, such a processor 102, and at least one memory, such as a memory 104. The memory 104 may be operably connectable to the processor 102. The memory 104 may store various types of information and/or instructions. The memory 104 may store a software code 105 which implements instructions that, when executed by the processor 102. perform the descriptions, functions, procedures, suggestions, methods and/or operational flowcharts disclosed in the present disclosure. For example, the software code 105 may implement instructions that, when executed by the processor 102, perform the descriptions, functions, procedures, suggestions, methods and/or operational flowcharts disclosed in the present disclosure. For example, the software code 105 may control the processor 102 to perform one or more protocols. For example, the software code 105 may control the processor 102 may perform one or more layers of the radio interface protocol.

The second wireless device 200 may include at least one transceiver, such as a transceiver 206, and at least one processing chip, such as a processing chip 201. The processing chip 201 may include at least one processor, such a processor 202, and at least one memory, such as a memory 204. The memory 204 may be operably connectable to the processor 202. The memory 204 may store various types of information and/or instructions. The memory 204 may store a software code 205 which implements instructions that, when executed by the processor 202, perform the descriptions, functions, procedures, suggestions, methods and/or operational flowcharts disclosed in the present disclosure. For example, the software code 205 may implement instructions that, when executed by the processor 202, perform the descriptions, functions, procedures, suggestions, methods and/or operational flowcharts disclosed in the present disclosure. For example, the software code 205 may control the processor 202 to perform one or more protocols. For example, the software code 205 may control the processor 202 may perform one or more layers of the radio interface protocol.

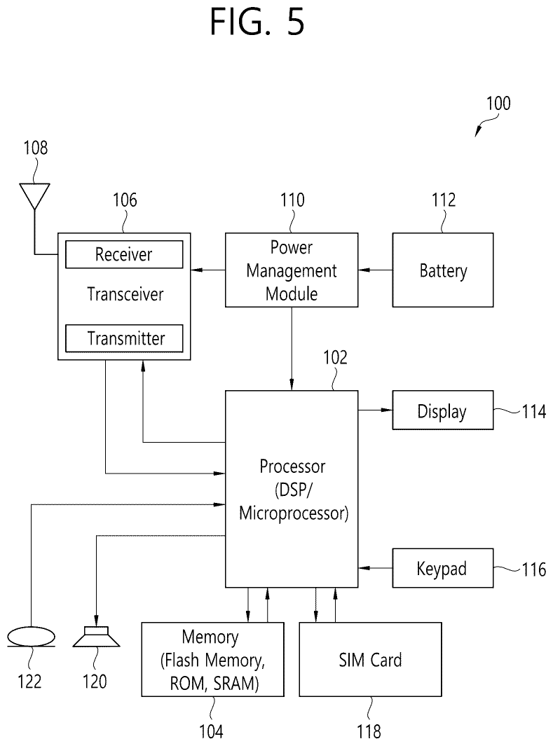

FIG. 5 shows an example of UE to which implementations of the present disclosure is applied.

Referring to FIG. 5, a UE 100 may correspond to the first wireless device 100 of FIG. 2 and/or the first wireless device 100 of FIG. 4.

A UE 100 includes a processor 102, a memory 104, a transceiver 106, one or more antennas 108, a power management module 110, a battery 1112, a display 114, a keypad 116, a subscriber identification module (SIM) card 118, a speaker 120, and a microphone 122.

The processor 102 may be configured to/adapted to implement the descriptions, functions, procedures, suggestions, methods and/or operational flowcharts disclosed in the present disclosure. The processor 102 may be configured to/adapted to control one or more other components of the UE 100 to implement the descriptions, functions, procedures, suggestions, methods and/or operational flowcharts disclosed in the present disclosure. Layers of the radio interface protocol may be implemented in the processor 102. The processor 102 may include ASIC, other chipset, logic circuit and/or data processing device. The processor 102 may be an application processor. The processor 102 may include at least one of a digital signal processor (DSP), a central processing unit (CPU), a graphics processing unit (GPU), a modem (modulator and demodulator). An example of the processor 102 may be found in SNAPDRAGON™ series of processors made by Qualcomm®, EXYNOS™ series of processors made by Samsung®, A series of processors made by Apple®, HELIO™ series of processors made by MediaTek®, ATOM™ series of processors made by Intel® or a corresponding next generation processor.

The memory 104 is operatively coupled with the processor 102 and stores a variety of information to operate the processor 102. The memory 104 may include ROM, RAM, flash memory, memory card, storage medium and/or other storage device. When the embodiments are implemented in software, the techniques described herein can be implemented with modules (e.g., procedures, functions, etc.) that perform the descriptions, functions, procedures, suggestions, methods and/or operational flowcharts disclosed in the present disclosure. The modules can be stored in the memory 104 and executed by the processor 102. The memory 104 can be implemented within the processor 102 or external to the processor 102 in which case those can be communicatively coupled to the processor 102 via various means as is known in the art.

The transceiver 106 is operatively coupled with the processor 102, and transmits and/or receives a radio signal. The transceiver 106 includes a transmitter and a receiver. The transceiver 106 may include baseband circuitry to process radio frequency signals. The transceiver 106 controls the one or more antennas 108 to transmit and/or receive a radio signal.

The power management module 110 manages power for the processor 102 and/or the transceiver 106. The battery 112 supplies power to the power management module 110.

The display 114 outputs results processed by the processor 102. The keypad 116 receives inputs to be used by the processor 102. The keypad 16 may be shown on the display 114.

The SIM card 118 is an integrated circuit that is intended to securely store the international mobile subscriber identity (IMSI) number and its related key, which are used to identify and authenticate subscribers on mobile telephony devices (such as mobile phones and computers). It is also possible to store contact information on many SIM cards.

The speaker 120 outputs sound-related results processed by the processor 102. The microphone 122 receives sound-related inputs to be used by the processor 102.

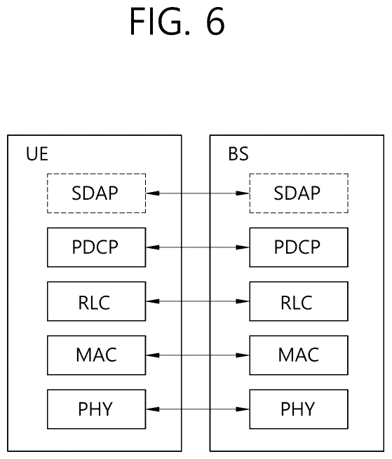

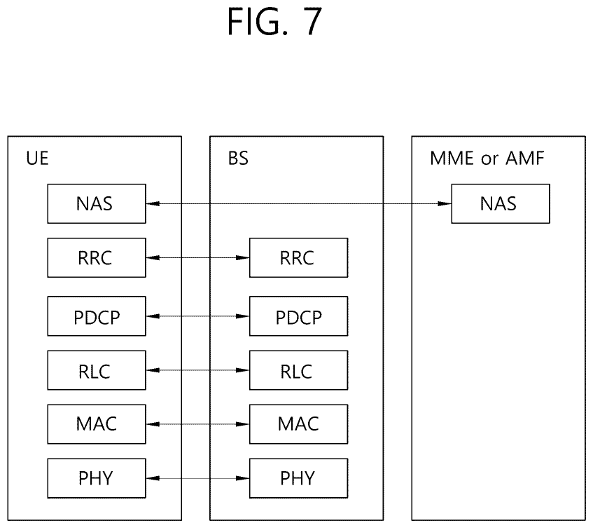

FIGS. 6 and 7 show an example of protocol stacks in a 3GPP based wireless communication system to which implementations of the present disclosure is applied.

In particular, FIG. 6 illustrates an example of a radio interface user plane protocol stack between a UE and a BS and FIG. 7 illustrates an example of a radio interface control plane protocol stack between a UE and a BS. The control plane refers to a path through which control messages used to manage call by a UE and a network are transported. The user plane refers to a path through which data generated in an application layer, for example, voice data or Internet packet data are transported. Referring to FIG. 6, the user plane protocol stack may be divided into Layer 1 (i.e., a PHY layer) and Layer 2. Referring to FIG. 7, the control plane protocol stack may be divided into Layer 1 (i.e., a PHY layer), Layer 2, Layer 3 (e.g., an RRC layer), and a non-access stratum (NAS) layer. Layer 1, Layer 2 and Layer 3 are referred to as an access stratum (AS).

In the 3GPP LTE system, the Layer 2 is split into the following sublayers: MAC, RLC, and PDCP. In the 3GPP NR system, the Layer 2 is split into the following sublayers: MAC, RLC, PDCP and SDAP. The PHY layer offers to the MAC sublayer transport channels, the MAC sublayer offers to the RLC sublayer logical channels, the RLC sublayer offers to the PDCP sublayer RLC channels, the PDCP sublayer offers to the SDAP sublayer radio bearers. The SDAP sublayer offers to 5G core network quality of service (QOS) flows.

In the 3GPP NR system, the main services and functions of the MAC sublayer include: mapping between logical channels and transport channels; multiplexing/de-multiplexing of MAC SDUs belonging to one or different logical channels into/from transport blocks (TB) delivered to/from the physical layer on transport channels; scheduling information reporting; error correction through hybrid automatic repeat request (HARQ) (one HARQ entity per cell in case of carrier aggregation (CA)); priority handling between UEs by means of dynamic scheduling; priority handling between logical channels of one UE by means of logical channel prioritization; padding. A single MAC entity may support multiple numerologies, transmission timings and cells. Mapping restrictions in logical channel prioritization control which numerology(ies), cell(s), and transmission timing(s) a logical channel can use.

Different kinds of data transfer services are offered by MAC. To accommodate different kinds of data transfer services, multiple types of logical channels are defined, i.e., each supporting transfer of a particular type of information. Each logical channel type is defined by what type of information is transferred. Logical channels are classified into two groups: control channels and traffic channels. Control channels are used for the transfer of control plane information only, and traffic channels are used for the transfer of user plane information only. Broadcast control channel (BCCH) is a downlink logical channel for broadcasting system control information, paging control channel (PCCH) is a downlink logical channel that transfers paging information, system information change notifications and indications of ongoing public warning service (PWS) broadcasts, common control channel (CCCH) is a logical channel for transmitting control information between UEs and network and used for UEs having no RRC connection with the network, and dedicated control channel (DCCH) is a point-to-point bi-directional logical channel that transmits dedicated control information between a UE and the network and used by UEs having an RRC connection. Dedicated traffic channel (DTCH) is a point-to-point logical channel, dedicated to one UE, for the transfer of user information. A DTCH can exist in both uplink and downlink. In downlink, the following connections between logical channels and transport channels exist: BCCH can be mapped to broadcast channel (BCH); BCCH can be mapped to downlink shared channel (DL-SCH); PCCH can be mapped to paging channel (PCH); CCCH can be mapped to DL-SCH; DCCH can be mapped to DL-SCH; and DTCH can be mapped to DL-SCH. In uplink, the following connections between logical channels and transport channels exist: CCCH can be mapped to uplink shared channel (UL-SCH); DCCH can be mapped to UL-SCH; and DTCH can be mapped to UL-SCH.

The RLC sublayer supports three transmission modes: transparent mode (TM). unacknowledged mode (UM), and acknowledged node (AM). The RLC configuration is per logical channel with no dependency on numerologies and/or transmission durations. In the 3GPP NR system, the main services and functions of the RLC sublayer depend on the transmission mode and include: transfer of upper layer PDUs; sequence numbering independent of the one in PDCP (UM and AM); error correction through ARQ (AM only); segmentation (AM and UM) and re-segmentation (AM only) of RLC SDUs; reassembly of SDU (AM and UM); duplicate detection (AM only); RLC SDU discard (AM and UM); RLC re-establishment; protocol error detection (AM only).

In the 3GPP NR system, the main services and functions of the PDCP sublayer for the user plane include: sequence numbering; header compression and decompression using robust header compression (ROHC); transfer of user data; reordering and duplicate detection; in-order delivery; PDCP PDU routing (in case of split bearers); retransmission of PDCP SDUs; ciphering, deciphering and integrity protection; PDCP SDU discard; PDCP re-establishment and data recovery for RLC AM; PDCP status reporting for RLC AM; duplication of PDCP PDUs and duplicate discard indication to lower layers. The main services and functions of the PDCP sublayer for the control plane include: sequence numbering; ciphering, deciphering and integrity protection; transfer of control plane data; reordering and duplicate detection; in-order delivery; duplication of PDCP PDUs and duplicate discard indication to lower layers.

In the 3GPP NR system, the main services and functions of SDAP include: mapping between a QoS flow and a data radio bearer; marking QoS flow ID (QFI) in both DL and UL packets. A single protocol entity of SDAP is configured for each individual PDU session.

In the 3GPP NR system, the main services and functions of the RRC sublayer include: broadcast of system information related to AS and NAS; paging initiated by 5GC or NG-RAN; establishment, maintenance and release of an RRC connection between the UE and NG-RAN; security functions including key management; establishment, configuration, maintenance and release of signaling radio bearers (SRBs) and data radio bearers (DRBs); mobility functions (including: handover and context transfer, UE cell selection and reselection and control of cell selection and reselection, inter-RAT mobility); QoS management functions; UE measurement reporting and control of the reporting; detection of and recovery from radio link failure; NAS message transfer to/from NAS from/to UE.

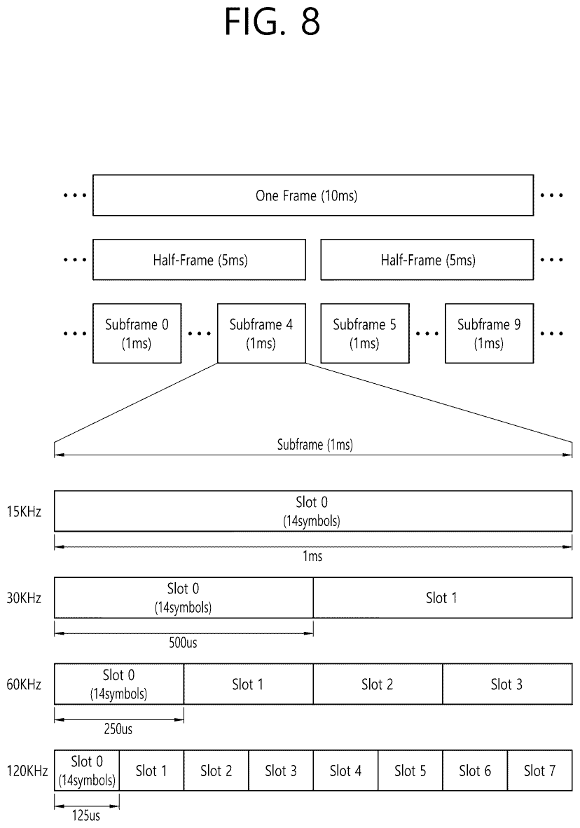

FIG. 8 shows a frame structure in a 3GPP based wireless communication system to which implementations of the present disclosure is applied.

The frame structure shown in FIG. 8 is purely exemplary and the number of subframes, the number of slots, and/or the number of symbols in a frame may be variously changed. In the 3GPP based wireless communication system, OFDM numerologies (e.g., subcarrier spacing (SCS), transmission time interval (TTI) duration) may be differently configured between a plurality of cells aggregated for one UE. For example, if a UE is configured with different SCSs for cells aggregated for the cell, an (absolute time) duration of a time resource (e.g., a subframe, a slot, or a TTI) including the same number of symbols may be different among the aggregated cells. Herein, symbols may include OFDM symbols (or CP-OFDM symbols), SC-FDMA symbols (or discrete Fourier transform-spread-OFDM (DFT-s-OFDM) symbols).

Referring to FIG. 8, downlink and uplink transmissions are organized into frames. Each frame has T_{f}=10 ms duration. Each frame is divided into two half-frames, where each of the half-frames has 5 ms duration. Each half-frame consists of 5 subframes, where the duration T_{sf} per subframe is 1 ms. Each subframe is divided into slots and the number of slots in a subframe depends on a subcarrier spacing. Each slot includes 14 or 12 OFDM symbols based on a cyclic prefix (CP). In a normal CP, each slot includes 14 OFDM symbols and, in an extended CP, each slot includes 12 OFDM symbols. The numerology is based on exponentially scalable subcarrier spacing βf=2^{u}*15 KHz.

Table 1 shows the number of OFDM symbols per slot N^{slot}_{symb}, the number of slots per frame N^{frame,u}ₛₗₒₜ, and the number of slots per subframe N^{subframe,u}ₛₗₒₜ for the normal CP, according to the subcarrier spacing βf=2^{u}*15 KHz.

TABLE 1

| u | N^{slot}_{symb} | N^{frame,u}ₛₗₒₜ | N^{subframe,u}ₛₗₒₜ |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

Table 2 shows the number of OFDM symbols per slot N^{slot}_{symb}, the number of slots per frame N^{frame,u}ₛₗₒₜ, and the number of slots per subframe N^{subframe,u}ₛₗₒₜ for the extended CP, according to the subcarrier spacing βf=2^{u}*15 kHz.

TABLE 2

| u | N^{slot}_{symb} | N^{frame,u}ₛₗₒₜ | N^{subframe,u}ₛₗₒₜ |
|---|---|---|---|
| 2 | 12 | 40 | 4 |

A slot includes plural symbols (e.g., 14 or 12 symbols) in the time domain. For each numerology (e.g., subcarrier spacing) and carrier, a resource grid of N^{size,u}_{grid,x}*N^{RB}_{sc} subcarriers and N^{subframe,u}_{symb} OFDM symbols is defined, starting at common resource block (CRB) N^{start,u}_{grid} indicated by higher-layer signaling (e.g., RRC signaling), where N^{size,u}_{grid,x} is the number of resource blocks (RBs) in the resource grid and the subscript x is DL for downlink and UL for uplink. N^{RB}_{sc} is the number of subcarriers per RB. In the 3GPP based wireless communication system, N^{RB}_{sc} is 12 generally. There is one resource grid for a given antenna port p, subcarrier spacing configuration u, and transmission direction (DL or UL). The carrier bandwidth N^{size,u}_{grid} for subcarrier spacing configuration u is given by the higher-layer parameter (e.g., RRC parameter). Each element in the resource grid for the antenna port p and the subcarrier spacing configuration u is referred to as a resource element (RE) and one complex symbol may be mapped to each RE. Each RE in the resource grid is uniquely identified by an index k in the frequency domain and an index l representing a symbol location relative to a reference point in the time domain. In the 3GPP based wireless communication system, an RB is defined by 12 consecutive subcarriers in the frequency domain. In the 3GPP NR system, RBs are classified into CRBs and physical resource blocks (PRBs). CRBs are numbered from 0 and upwards in the frequency domain for subcarrier spacing configuration u. The center of subcarrier 0 of CRB 0 for subcarrier spacing configuration u coincides with ‘point A’ which serves as a common reference point for resource block grids. In the 3GPP NR system, PRBs are defined within a bandwidth part (BWP) and numbered from 0 to N^{size}_{BWP,i}−1, where i is the number of the bandwidth part. The relation between the physical resource block nPRB in the bandwidth part i and the common resource block n_{CRB} is as follows: n_{PRB}=n_{CRB}+N^{size}_{BWP,i}. where N^{sizeBWP,i} is the common resource block where bandwidth part starts relative to CRB 0. The BWP includes a plurality of consecutive RBs. A carrier may include a maximum of N (e.g., 5) BWPs. A UE may be configured with one or more BWPs on a given component carrier. Only one BWP among BWPs configured to the UE can active at a time. The active BWP defines the UE's operating bandwidth within the cell's operating bandwidth.

The NR frequency band may be defined as two types of frequency range, i.e., FR1 and FR2. The numerical value of the frequency range may be changed. For example, the frequency ranges of the two types (FR1 and FR2) may be as shown in Table 3 below. For ease of explanation, in the frequency ranges used in the NR system, FRI may mean “sub 6 GHz range”, FR2 may mean “above 6 GHz range,” and may be referred to as millimeter wave (mmW).

TABLE 3

| Frequency | Corresponding | Subcarrier |
|---|---|---|
| Range | frequency range | Spacing |
| FR1 | 450 MHz-6000 MHz | 15, 30, 60 kHz |
| FR2 | 24250 MHz-52600 MHz | 60, 120, 240 kHz |

As mentioned above, the numerical value of the frequency range of the NR system may be changed. For example, FR1 may include a frequency band of 410 MHz to 7125 MHz as shown in Table 4 below. That is, FR1 may include a frequency band of 6 GHz (or 5850, 5900, 5925 MHz, etc.) or more. For example, a frequency band of 6 GHz (or 5850, 5900, 5925 MHZ, etc.) or more included in FR1 may include an unlicensed band. Unlicensed bands may be used for a variety of purposes, for example for communication for vehicles (e.g., autonomous driving).

TABLE 4

| Frequency Range | Corresponding | Subcarrier |
|---|---|---|
| designation | frequency range | Spacing |
| FR1 | 410 MHz-7125 MHz | 15, 30, 60 kHz |
| FR2 | 24250 MHz-52600 MHz | 60, 120, 240 kHz |

In the present disclosure, the term “cell” may refer to a geographic area to which one or more nodes provide a communication system, or refer to radio resources. A “cell” as a geographic area may be understood as coverage within which a node can provide service using a carrier and a “cell” as radio resources (e.g., time-frequency resources) is associated with bandwidth which is a frequency range configured by the carrier. The “cell” associated with the radio resources is defined by a combination of downlink resources and uplink resources, for example, a combination of a DL component carrier (CC) and a UL CC. The cell may be configured by downlink resources only, or may be configured by downlink resources and uplink resources. Since DL coverage, which is a range within which the node is capable of transmitting a valid signal, and UL coverage, which is a range within which the node is capable of receiving the valid signal from the UE, depends upon a carrier carrying the signal, the coverage of the node may be associated with coverage of the “cell” of radio resources used by the node. Accordingly, the term “cell” may be used to represent service coverage of the node sometimes, radio resources at other times. or a range that signals using the radio resources can reach with valid strength at other times. In CA, two or more CCs are aggregated. A UE may simultaneously receive or transmit on one or multiple CCs depending on its capabilities. CA is supported for both contiguous and non-contiguous CCs. When CA is configured, the UE only has one RRC connection with the network. At RRC connection establishment/re-establishment/handover, one serving cell provides the NAS mobility information, and at RRC connection re-establishment/handover. one serving cell provides the security input. This cell is referred to as the primary cell (PCell). The PCell is a cell, operating on the primary frequency, in which the UE either performs the initial connection establishment procedure or initiates the connection re-establishment procedure. Depending on UE capabilities. secondary cells (SCells) can be configured to form together with the PCell a set of serving cells. An SCell is a cell providing additional radio resources on top of special cell (SpCell). The configured set of serving cells for a UE therefore always consists of one PCell and one or more SCells. For dual connectivity (DC) operation. the term SpCell refers to the PCell of the master cell group (MCG) or the primary SCell (PSCell) of the secondary cell group (SCG). An SpCell supports PUCCH transmission and contention-based random access, and is always activated. The MCG is a group of serving cells associated with a master node, comprised of the SpCell (PCell) and optionally one or more SCells. The SCG is the subset of serving cells associated with a secondary node. comprised of the PSCell and zero or more SCells. for a UE configured with DC. For a UE in RRC_CONNECTED not configured with CA/DC. there is only one serving cell comprised of the PCell. For a UE in RRC_CONNECTED configured with CA/DC, the term “serving cells” is used to denote the set of cells comprised of the SpCell(s) and all SCells. In DC. two MAC entities are configured in a UE: one for the MCG and one for the SCG.

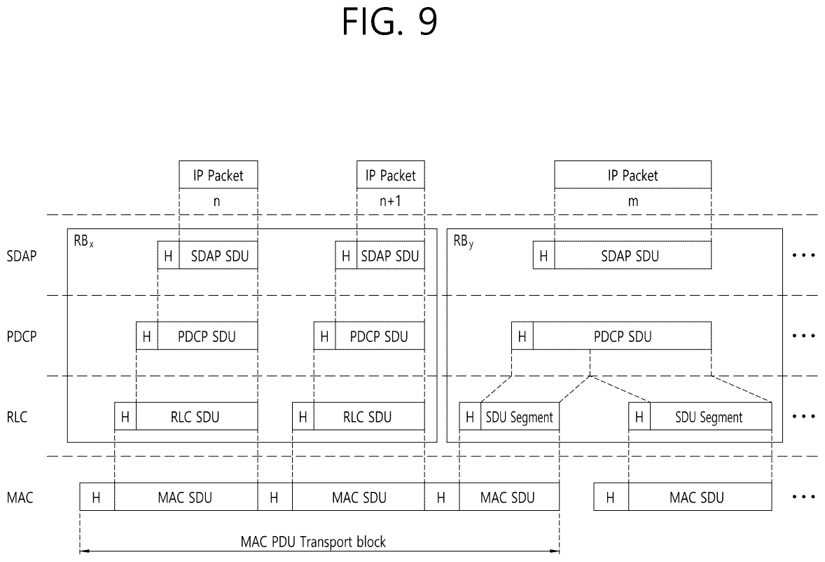

FIG. 9 shows a data flow example in the 3GPP NR system to which implementations of the present disclosure is applied.

Referring to FIG. 9. “RB” denotes a radio bearer. and “H” denotes a header. Radio bearers are categorized into two groups: DRBs for user plane data and SRBs for control plane data. The MAC PDU is transmitted/received using radio resources through the PHY layer to/from an external device. The MAC PDU arrives to the PHY layer in the form of a transport block.

In the PHY layer. the uplink transport channels UL-SCH and RACH are mapped to their physical channels physical uplink shared channel (PUSCH) and physical random access channel (PRACH), respectively, and the downlink transport channels DL-SCH, BCH and PCH are mapped to physical downlink shared channel (PDSCH), physical broadcast channel (PBCH) and PDSCH, respectively. In the PHY layer, uplink control information (UCI) is mapped to physical uplink control channel (PUCCH), and downlink control information (DCI) is mapped to physical downlink control channel (PDCCH). A MAC PDU related to UL-SCH is transmitted by a UE via a PUSCH based on an UL grant, and a MAC PDU related to DL-SCH is transmitted by a BS via a PDSCH based on a DL assignment.

Hereinafter, mobility is described.

In the disclosure, ‘Mobility’ refers to a procedure for i) changing a PCell of a UE (i.e., handover or PCell change), ii) changing a PSCell of a UE (i.e., SN change or PSCell change), and/or iii) adding a PSCell for a UE (i.e., SN addition or PSCell addition). Therefore, the mobility may comprise at least one of a handover, an SN change or an SN addition. In other words, the mobility may comprise at least one of PCell change, PSCell change or PSCell addition. Throughout the disclosure, performing a mobility to a target cell may refer to applying a mobility command of the target cell or applying a target cell configuration for the target cell in the mobility command of the target cell. The target cell configuration for the target cell may comprise RRC reconfiguration parameters associated with the mobility to the target cell. Further, RRC reconfiguration and RRC connection reconfiguration may be used interchangeably.

In the disclosure, the target cell configuration may also be referred to as candidate cell configuration. The candidate cell configuration may comprise reconfigurationWithSync, which comprise parameters for the synchronous reconfiguration to the target SpCell. For example, the reconfigurationWithSync may comprise at least one of a new UE-identity (i.e., a kind of RNTI value), timer T304, spCellConfigCommon, rach-ConfigDedicated or smtc. The spCellConfigCommon may comprise ServingCellConfigCommon which is used to configure cell specific parameters of a UE's serving cell. The rach-ConfigDedicated may indicate a random access configuration to be used for a reconfiguration with sync (e.g., mobility). The smtc may indicate a synchronization signal/physical broadcast channel (SS/PBCH) block periodicity/offset/duration configuration of target cell for PSCell change, PCell change and/or PSCell addition. The SS/PBCH block may be simply referred to as synchronization signal block (SSB).

‘SN mobility’ refers to a procedure for i) changing a PSCell of a UE (i.e., SN change or PSCell change), and/or ii) adding a PSCell for a UE (i.e., SN addition or PSCell addition). Therefore, the SN mobility may comprise at least one of an SN change or an SN addition. In other words, the SN mobility may comprise at least one of PSCell change or PSCell addition. Throughout the disclosure, performing an SN mobility to a target cell may refer to applying an SN mobility command of the target cell or applying a target cell configuration for the target cell in the SN mobility command of the target cell. The target cell configuration for the target cell may comprise RRC reconfiguration parameters associated with the SN mobility to the target cell. The SN mobility may be a kind of a mobility. The SN mobility command may comprise a SN change command for performing SN change, or SN addition command for performing SN addition.

‘Mobility condition for a target cell’ refers to a triggering condition for a mobility to the target cell. That is, the mobility condition for a target cell refers to a condition that should be satisfied for triggering a mobility to the target cell. Mobility condition may comprise at least one of event A3 condition (i.e., mobility condition for event A3) or event A5 condition (i.e., mobility condition for event A5). The event A3 condition may comprise at least one of an offset value, or a time-to-trigger (TTT). The event A5 condition may comprise at least one of a serving cell threshold, a target cell threshold, or a TTT. The mobility condition for an event may be satisfied if/when an entering condition (or, also referred to as entry condition) for the event is satisfied for at least the TTT. For example, the entering condition for event A3 may be satisfied if a signal quality for a target cell is better than that for a serving cell more than or equal to the offset value. For another example, an entering condition for event A5 may be satisfied if a signal quality for a target cell is better than the target cell threshold and a signal quality for a serving cell is lower than the serving cell threshold. The mobility condition may also be referred to as an execution condition/conditional execution condition/conditional mobility execution condition (e.g., CHO execution condition).

‘SN mobility condition for a target cell’ refers to a triggering condition for an SN mobility (i.e., SN addition or SN change) to the target cell. That is, the SN mobility condition for a target cell refers to a condition that should be satisfied for triggering an SN mobility to the target cell. SN mobility condition for a target cell may be classified as:
i) SN addition condition for a target cell, which refers to a triggering condition for an SN addition of the target cell; or
ii) SN change condition for a target cell, which refers to a triggering condition for an SN change to the target cell.

SN mobility condition may comprise at least one of an event, time-to-trigger (TTT). offset value, or threshold value(s). The SN mobility condition for an event may be satisfied if an entering condition for the event is satisfied for at least the TTT.

For example, SN addition condition may be related to event A4 or event B1. The entering condition for event A4 or B1 may be satisfied if a signal quality for a target cell is better than a threshold.

For example. SN change condition may be related to event A3 or event A5. The entering condition for event A3 may be satisfied if a signal quality for a target cell is better than that for a source PScell more than or equal to the offset value. For another example, the entering condition for event A5 may be satisfied if a signal quality for a target cell is better than a first threshold and a signal quality for a source PScell is lower than a second threshold.

‘Conditional mobility’ refers to a mobility that is performed to a target cell which satisfies a triggering condition among a plurality of candidate target cells. Throughout the disclosure, performing a conditional mobility to a target cell may refer to applying a conditional mobility command of a target cell which satisfies a mobility condition for the target cell among a plurality of candidate target cells or applying a target cell configuration for the target cell in the conditional mobility command of the target cell which satisfies a mobility condition for the target cell among the plurality of candidate target cells. The target cell configuration for the target cell may comprise RRC reconfiguration parameters associated with the conditional mobility to the target cell. Conditional mobility may comprise a conditional handover (i.e., conditional PCell change), a conditional SN change (i.e., conditional PSCell change (CPC)). and/or conditional SN addition (i.e., conditional PSCell addition (CPA)). The conditional PSCell addition/change (CPAC) may comprise the CPC and/or the CPA.

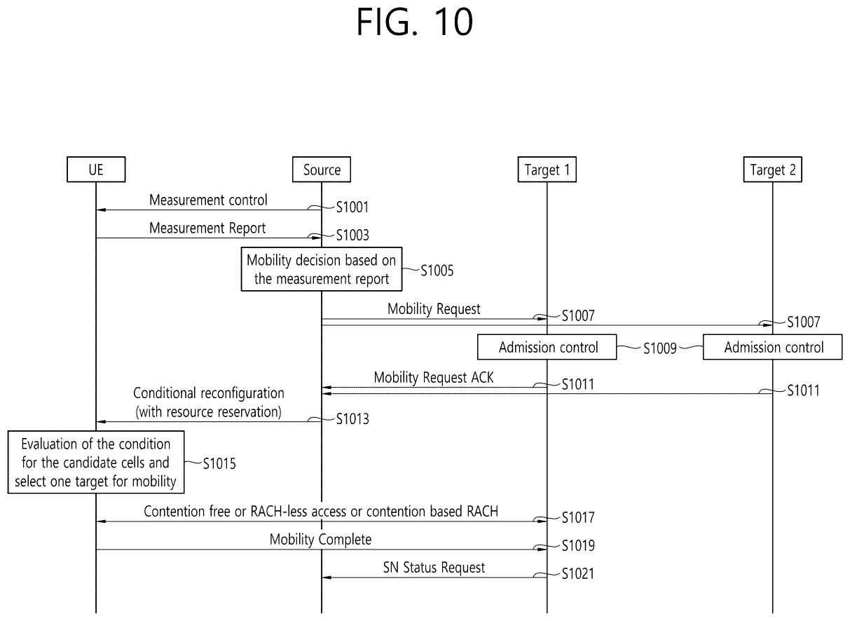

FIG. 10 shows an example of a conditional mobility procedure to which technical features of the present disclosure can be applied. The steps illustrated in FIG. 10 can also be applied to a conditional handover procedure, conditional SN addition procedure and/or conditional SN change procedure.

Referring to FIG. 10, in step S1001, the source cell may transmit measurement control message to the UE. The source cell may configure the UE measurement procedures according to the roaming and access restriction information and, for example, the available multiple frequency band information through the measurement control message. Measurement control information provided by the source cell through the measurement control message may assist the function controlling the UE's connection mobility. For example, the measurement control message may comprise a measurement configuration including a list of measurement configurations, and each measurement configuration in the list includes a measurement identity (ID), the corresponding measurement object and the corresponding report configuration.

In step S1003, the UE may transmit a measurement report message to the source cell. The measurement report message may comprise a result of measurement on neighbor cell(s) around the UE which can be detected by the UE. The UE may generate the measurement report message according to a measurement configuration and/or measurement control information in the measurement control message received in step S1001.

In step S1005, the source cell may make a mobility decision based on the measurement report. For example, the source cell may make a mobility decision and determine candidate target cells (e.g., target cell 1 and target cell 2) for mobility among neighbor cells around the UE based on a result of measurement (e.g., signal quality, reference signal received power (RSRP), reference signal received quality (RSRP)) on the neighbor cells.

In step S1007, the source cell may transmit mobility request messages to the target cell 1 and the target cell 2 which are determined in step S1005. That is, the source cell may perform mobility preparation with the target cell 1 and the target cell 2. The mobility request message may comprise necessary information to prepare the mobility at the target side (e.g., target cell 1 and target cell 2).

In step S1009, each of the target cell 1 and the target cell 2 may perform an admission control based on information included in the mobility request message. The target cell may configure and reserve the required resources (e.g., C-RNTI and/or RACH preamble). The AS-configuration to be used in the target cell can either be specified independently (i.e. an “establishment”) or as a delta compared to the AS-configuration used in the source cell (i.e. a “reconfiguration”).

In step S1011, the target cell and the target cell 2 may transmit a mobility request acknowledge (ACK) message to the source cell. The mobility request ACK message may comprise target cell configuration (i.e., RRCReconfiguration message including ReconfigurationWithSync) including information on resources reserved and prepared for a mobility. For example, the mobility request ACK message may comprise a transparent container to be sent to the UE as an RRC message (i.e., RRCReconfiguration message/target cell configuration) to perform the mobility. The container/target cell configuration/RRC Reconfiguration message may include a new C-RNTI, target gNB security algorithm identifiers for the selected security algorithms, access configuration such as dedicated RACH resources including dedicated preamble, and/or possibly some other parameters i.e., access parameters, SIBs. If RACH-less mobility is configured, the container may include timing adjustment indication and optionally a preallocated uplink grant. The mobility request ACK message may also include RNL/TNL information for forwarding tunnels, if necessary. As soon as the source cell receives the mobility request ACK message, or as soon as the transmission of the conditional mobility command is initiated in the downlink, data forwarding may be initiated.

In step S1013, the source cell may transmit a RRCReconfiguration message including a conditional reconfiguration to the UE. The conditional reconfiguration may be also referred to as (or, may comprise) conditional handover (CHO) configuration and/or a conditional mobility command (e.g., CHO command). The conditional reconfiguration may comprise a list of conditional reconfigurations/conditional mobility commands, including a conditional reconfiguration/conditional mobility command for each of the candidate target cells (e.g., target cell 1, target cell 2). For example, the conditional reconfiguration may comprise a conditional reconfiguration/conditional mobility command for the target cell 1, and a conditional reconfiguration/conditional mobility command for the target cell 2. The conditional reconfiguration for the target cell 1 may comprise an index/identifier identifying the corresponding conditional reconfiguration, a mobility condition for the target cell 1, and/or a target cell configuration for the target cell 1. The target cell configuration for the target cell l (i.e., RRCReconfiguration message including ReconfigurationWithSync for the target cell 1 received from the target cell 1 in step S1011) may comprise RRC reconfiguration parameters associated with a mobility to the target cell 1, including information on resources reserved and prepared for the mobility to the target cell 1. Similarly, the conditional reconfiguration for the target cell 2 may comprise an index/identifier identifying the corresponding conditional reconfiguration, a mobility condition for the target cell 2, and a target cell configuration for the target cell 2. The target cell configuration for the target cell 2 (i.e., RRCReconfiguration message including ReconfigurationWithSync for the target cell 2 received from the target cell 2 in step S1011) may comprise RRC reconfiguration parameters associated with a mobility to the target cell 2, including information on resources reserved and prepared for the mobility to the target cell 2.

The mobility condition may inform at least one measurement ID. For example, the mobility condition may inform at most 2 measurement IDs. If a mobility condition of a target cell informs a measurement ID which is related to a report configuration, the mobility condition of the target cell may be a condition (e.g., event A3 condition or event A5 condition) specified/indicated by a conditional reconfiguration triggering configuration (i.e., CondTriggerConfig) in the report configuration. The conditional reconfiguration triggering configuration may further specify/indicate a type of reference signal to measure for evaluating the mobility condition.

For example, the conditional reconfiguration (i.e., ConditionalReconfiguration) may comprise a list of conditional reconfigurations (i.e., CondReconfigToAddModList), as shown in table 5:

TABLE 5

ConditionalReconfiguration-r16 := SEQUENCE { attemptCondReconfig-r16
ENUMERATED {true} OPTIONAL, -- Cond CHO
condReconfigToRemoveList-r16 CondReconfigToRemoveList-r16
OPTIONAL, -- Need N condReconfigToAddModList-r16
CondReconfigToAddModList-r16 OPTIONAL, -- Need
N ...}CondReconfigToRemoveList-r16 ::= SEQUENCE (SIZE (1..
maxNrofCondCells-r16)) OF CondReconfigId-r16

In table 5, if attemptCondReconfig is present, the UE shall perform conditional reconfiguration if selected cell is a target candidate cell and it is the first cell selection after failure. CondReconfigToAddModList may be a list of the configuration of candidate SpCells to be added or modified for CHO or CPC. condReconfigToRemoveList may be a list of the configuration of candidate SpCells to be removed. Each conditional reconfiguration (i.e., CondReconfigToAddMod) in the CondReconfigToAddModList may comprise an index/identifier identifying the corresponding g conditional reconfiguration (i.e., condReconfigld), a mobility condition (i.e., condExecutionCond), and a target cell configuration (i.e., condRRCReconfig) as shown in table 6:

TABLE 6

CondReconfigToAddModList-r16 ::= SEQUENCE (SIZE (1.. maxNrofCondCells-r16)) OF
CondReconfigToAddMod-r16CondReconfigToAddMod-r16 ::= SEQUENCE
{ condReconfigId-r16 CondReconfigId-r16, condExecutionCond-
r16 SEQUENCE (SIZE (1..2)) OF MeasId
OPTIONAL, -- Cond condReconfigAdd condRRCReconfig-r16
OCTET STRING (CONTAINING RRCReconfiguration) OPTIONAL, --
Cond condReconfigAdd ...}

In table 6, condExecutionCond may be the execution condition that needs to be fulfilled in order to trigger the execution of a conditional reconfiguration. When configuring 2 triggering events (Meas Ids) for a candidate cell, network ensures that both refer to the same measObject. condRRCReconfig may be the RRCReconfiguration message including ReconfigurationWithSync to be applied when the condition(s) are fulfilled. In step S1015, the UE may perform an evaluation of the mobility condition for the candidate target cells (e.g., target cell 1, target cell 2) and select a target cell for a mobility among the candidate target cells. For example, the UE may perform measurements on the candidate target cells, and determine whether a candidate target cell satisfies a mobility condition for the candidate target cell among the candidate target cells based on a result of the measurements on the candidate target cells. Or, the UE may determine whether the target cell/measurement result for the target cell satisfies the mobility condition of the target cell. If the UE identifies that the target cell 1 satisfies a mobility condition for the target cell 1, the UE may select the target cell 1 as a target cell for the mobility. Then, the UE may apply the target cell configuration for the selected target cell (i.e., execute conditional reconfiguration for the selected target cell/initiate conditional mobility to the selected target cell) and/or initiate a random access procedure to the selected target cell. Upon applying the target cell configuration for the selected target cell and/or initiating the random access procedure to the selected target cell, the UE may start T304 timer.

In step S1017, the UE may perform conditional mobility to the selected target cell while the T304 timer is running. For example, the UE may transmit a random access preamble to the target cell 1, and receive a random access response comprising an uplink grant from the target cell 1. If RACH-less mobility is configured, the uplink grant may be provided in step S1013.

In step S1019, the UE may transmit a mobility complete message (i.e., RROReconfigurationComplete message) to the target cell 1. When the UE has successfully accessed the target cell 1 (or, received uplink grant when RACH-less mobility is configured), the UE may transmit, based on the received uplink grant, a mobility complete message comprising a C-RNTI to confirm the mobility, along with uplink buffer status report, whenever possible, to the target cell 1 to indicate that the mobility procedure is completed for the UE. The target cell 1 may verify the C-RNTI transmitted in the mobility complete message.

Upon successful completion of the conditional mobility to the target cell (i.e., upon successful completion of the random access procedure to the target cell and/or upon transmitting the mobility complete message to the target cell), the UE may stop the T304 timer. On the other hand, when the T304 timer is not stopped and expires, the UE may detect a mobility failure/conditional mobility failure, store failure information related to the conditional mobility failure (i.e., conditional mobility failure information or mobility failure information) in a failure report (i.e., VarRLF-report or RLF-report in VarRLF-report), and initiate an RRC re-establishment procedure.

The UE shall:
1> if T304 of the MCG expires:
2> release dedicated preambles provided in rach-ConfigDedicated if configured;
2> release dedicated msgA PUSCH resources provided in rach-ConfigDedicated if configured;
2> if any DAPS bearer is configured, and radio link failure is not detected in the source PCell;
3> reset MAC for the target PCell and release the MAC configuration for the target PCell;
3> for each DAPS bearer:
4> release the RLC entity or entities, and the associated logical channel for the target PCell;
4> reconfigure the PDCP entity to release DAPS;
3> for each SRB:
4> if the master KeyUpdate was not received:
5> configure the PDCP entity for the source PCell with state variables continuation;
4> release the PDCP entity for the target PCell;
4> release the RLC entity, and the associated logical channel for the target PCell;
4> trigger the PDCP entity for the source PCell to perform SDU discard;
4> re-establish the RLC entity for the source PCell;
3> release the physical channel configuration for the target PCell;
3> discard the keys used in target PCell (the K_{gNB} key, the K_{RRCenc} key, the K_{RRCint} key, the K_{UPint} key and the K_{UPene} key), if any;
3> resume suspended SRBs in the source PCell;
3> for each non-DAPS bearer:
4> revert back to the UE configuration used for the DRB in the source PCell, includes PDCP, RLC states variables, the security configuration and the data stored in transmission and reception buffers in PDCP and RLC entities;
3> revert back to the UE measurement configuration used in the source PCell;
3> initiate the failure information procedure to report DAPS handover failure.
2> else:
3> revert back to the UE configuration used in the source PCell;
3> store the handover failure information in VarRLF-Report;
3> initiate the connection re-establishment procedure.

Hereinafter, radio link failure (RLF) related actions are described.

In some implementations, the UE may detect physical layer problems in RRC_CONNECTED. For example, if any DAPS bearer is configured, upon receiving N310 consecutive “out-of-sync” indications for the source SpCell from lower layers and T304 is running, the UE may detect physical layer problems and start timer T310 for the source SpCell. For another example, upon receiving N310 consecutive “out-of-sync” indications for the SpCell from lower layers while neither T300, T301, T304, T311, T316 nor T319 are running, the UE may the UE may detect physical layer problems and start timer T310 for the corresponding SpCell.

In some implementations, the UE may detect recovery of physical layer problems and stop timer T310/T312 for the corresponding SpCell upon receiving N311 consecutive “in-sync” indications for the SpCell from lower layers while T310 is running.

The UE shall:
1> if any DAPS bearer is configured and T304 is running:
2> upon T310 expiry in source SpCell; or
2> upon random access problem indication from source MCG MAC; or
2> upon indication from source MCG RLC that the maximum number of retransmissions has been reached; or
2> upon consistent uplink LBT failure indication from source MCG MAC:
3> consider radio link failure to be detected for the source MCG i.e. source RLF;
3> suspend the transmission and reception of all DRBs in the source MCG;
3> reset MAC for the source MCG;
3> release the source connection.
1> else:
2> during a DAPS handover; the following only applies for the target PCell;
2> upon T310 expiry in PCell; or
2> upon T312 expiry in PCell; or
2> upon random access problem indication from MCG MAC while neither T300, T301, T304, T311 nor T319 are running; or
2> upon indication from MCG RLC that the maximum number of retransmissions has been reached; or
2> if connected as an IAB-node, upon BH RLF indication received on BAP entity from the MCG; or
2> upon consistent uplink LBT failure indication from MCG MAC while T304 is not running;
3> if the indication is from MCG RLC and CA duplication is configured and activated for MCG, and for the corresponding logical channel allowedServingCells only includes SCell(s):
4> initiate the failure information procedure to report RLC failure.
3> else:
4> consider radio link failure to be detected for the MCG, i.e. MCG RLF;
4> discard any segments of segmented RRC messages;
4> if AS security has not been activated:
5> perform the actions upon going to RRC_IDLE, with release cause ‘other’;
4> else if AS security has been activated but SRB2 and at least one DRB or, for IAB, SRB2, have not been setup:
5> store the radio link failure information (i.e., failure information related to RLF) in the VarRLF-Report;
5> perform the actions upon going to RRC_IDLE, with release cause ‘RRC connection failure’;
4> else:
5> store the radio link failure information in the VarRLF-Report;
5> if T316 is configured; and
5> if SCG transmission is not suspended; and
5> if neither PSCell change nor PSCell addition is ongoing (i.e. timer T304 for the NR
PSCell is not running in case of NR-DC or timer T307 of the E-UTRA PSCell is not running, in NE-DC):
6> initiate the MCG failure information procedure to report MCG radio link failure.
5> else:
6> initiate the connection re-establishment procedure.

The UE shall determine the content in the VarRLF-Report as follows:
1> clear the information included in VarRLF-Report, if any;
1> set the plmn-IdentityList to include the list of EPLMNs stored by the UE (i.e. includes the RPLMN);
1> set the measResultLastServCell to include the cell level RSRP, RSRQ and the available SINR, of the source PCell (in case HO failure) or PCell (in case RLF) based on the available SSB and CSI-RS measurements collected up to the moment the UE detected failure;
1> if the SS/PBCH block-based measurement quantities are available:
2> set the rsIndexResults in measResultLastServCell to include all the available measurement quantities of the source PCell (in case HO failure) or PCell (in case RLF), ordered such that the highest SS/PBCH block RSRP is listed first if SS/PBCH block RSRP measurement results are available, otherwise the highest SS/PBCH block RSRQ is listed first if SS/PBCH block RSRQ measurement results are available, otherwise the highest SS/PBCH block SINR is listed first, based on the available SS/PBCH block based measurements collected up to the moment the UE detected failure;
1> if the CSI-RS based measurement quantities are available:
2> set the rsIndexResults in measResultLastServCell to include all the available measurement quantities of the source PCell (in case HO failure) or PCell (in case RLF), ordered such that the highest CSI-RS RSRP is listed first if CSI-RS RSRP measurement results are available, otherwise the highest CSI-RS RSRQ is listed first if CSI-RS RSRQ measurement results are available, otherwise the highest CSI-RS SINR is listed first, based on the available CSI-RS based measurements collected up to the moment the UE detected failure;
1> set the ssbRLMConfigBitmap and/or csi-rsRLMConfigBitmap in meas ResultLastServCell to include the radio link monitoring configuration of the source PCell (in case HO failure) or PCell (in case RLF), if available;
1> for each of the configured meas ObjectNR in which measurements are available:
2> if the SS/PBCH block-based measurement quantities are available:
3> set the measResultListNR in measResultNeighCells to include all the available measurement quantities of the best measured cells, other than the source PCell (in case HO failure) or PCell (in case RLF), ordered such that the cell with highest SS/PBCH block RSRP is listed first if SS/PBCH block RSRP measurement results are available, otherwise the cell with highest SS/PBCH block RSRQ is listed first if SS/PBCH block RSRQ measurement results are available, otherwise the cell with highest SS/PBCH block SINR is listed first, based on the available SS/PBCH block based measurements collected up to the moment the UE detected failure;
4> for each neighbour cell included, include the optional fields that are available;
2> if the CSI-RS based measurement quantities are available:
3> set the measResultListNR in measResultNeighCells to include all the available measurement quantities of the best measured cells, other than the source PCell (in case HO failure) or PCell (in case RLF), ordered such that the cell with highest CSI-RS RSRP is listed first if CSI-RS RSRP measurement results are available, otherwise the cell with highest CSI-RS RSRQ is listed first if CSI-RS RSRQ measurement results are available, otherwise the cell with highest CSI-RS SINR is listed first, based on the available CSI-RS based measurements collected up to the moment the UE detected radio link failure;
4> for each neighbour cell included, include the optional fields that are available;
2> for each neighbour cell, if any, included in measResultListNR in meas ResultNeighCells:
3> if the UE supports RLF-Report for conditional handover and if the neighbour cell is one of the candidate cells for which the reconfigurationWithSync is included in the masterCellGroup in the MCG VarConditionalReconfig at the moment of the detected failure:
4> set choConfig in Meas Result2NR to the execution condition for each measId within condTriggerConfig associated to the neighbour cell within the MCG VarConditionalReconfig;
4> if the first entry of choConfig corresponds to a fulfilled execution condition at the moment of handover failure, or radio link failure; or
4> if the second entry of choConfig, if available, corresponds to a fulfilled execution condition at the moment of handover failure, or radio link failure;
5> set firstTriggeredEvent to the execution condition condFirstEvent corresponding to the first entry of choConfig or to the execution condition condSecondEvent corresponding to the second entry of choConfig, whichever execution condition was fulfilled first in time;
5> set timeBetweenEvents to the elapsed time between the point in time of fullfilling the condition in choConfig that was fulfilled first in time, and the point in time of fullfilling the condition in choConfig that was fulfilled second in time, if both the first execution condition corresponding to the first entry and the second execution condition corresponding to the second entry in the choConfig were fullfilled;
1> for each of the configured EUTRA frequencies in which measurements are available;
2> set the measResultListEUTRA in measResultNeighCells to include the best measured cells ordered such that the cell with highest RSRP is listed first if RSRP measurement results are available, otherwise the cell with highest RSRQ is listed first, and based on measurements collected up to the moment the UE detected failure;
3> for each neighbour cell included, include the optional fields that are available;
1> set the c-RNTI to the C-RNTI used in the source PCell (in case HO failure) or PCell (in case RLF);
1> if the failure is detected due to reconfiguration with sync failure (i.e., mobility failure), set the fields in VarRLF-report as follows:
2> set the connectionFailureType to hof;
2> if the UE supports RLF-Report for DAPS handover and if any DAPS bearer was configured while T304 was running:
3> set lastHO-Type to daps;
3> if radio link failure was detected in the source PCell:
4> set timeConnSourceDAPS-Failure to the time between the initiation of the DAPS handover execution and the radio link failure detected in the source PCell while T304 was running;
4> set the rlf-Cause to the trigger for detecting the source radio link failure;
2> if the UE supports RLF-Report for conditional handover and if configuration of the conditional handover is available in the MCG VarConditionalReconfig at the moment of the handover failure:
3> if the UE executed a conditional handover toward target PCell according to the condRRCReconfig of the target PCell:
4> set timeSinceCHO-Reconfig to the time elapsed between the execution of the last RRCReconfiguration message including reconfigurationWithSync for the target PCell of the failed conditional handover, and the reception in the source PCell of the last conditionalReconfiguration including the condRRCReconfig of the target PCell of the failed conditional handover;
3> else:
4> set timeSinceCHO-Reconfig to the time elapsed between the execution of the last RRCReconfiguration message including reconfigurationWithSync for the target PCell of the failed handover, and the reception in the source PCell of the last conditionalReconfiguration including the condRRCReconfig;
3> set choCandidateCellList to include the global cell identity, if available, and otherwise to the physical cell identity and carrier frequency of each of the candidate target cells for conditional handover included in condRRCReconfig within the MCG VarConditionalReconfig at the time of the failed handover, excluding the candidate target cells included in measResulNeighCells;
2> if the UE supports RLF-Report for conditional handover and if the last executed RRCReconfiguration message including reconfigurationWithSync was concerning a conditional handover;
3> set lastHO-Type to cho;
2> set the nrFailedPCellId in failedPCellId to the global cell identity and tracking area code, if available, and otherwise to the physical cell identity and carrier frequency of the target PCell of the failed handover;
2> include nrPreviousCell in previousPCellId and set it to the global cell identity and tracking area code of the PCell where the last RRCReconfiguration message including reconfigurationWithSync was received;
2> set the timeConnFailure to the elapsed time since the execution of the last RRCReconfiguration message including the reconfigurationWithSync;
1> else if the failure is detected due to Mobility from NR failure, set the fields in VarRLF-report as follows:
2> set the connectionFailureType to hof.
2> if last MobilityFromNRCommand concerned a failed inter-RAT handover from NR to E-UTRA and if the UE supports Radio Link Failure Report for Inter-RAT MRO EUTRA (NR to EUTRA):
3> set the eutraFailedPCellId in failedPCellId to the global cell identity and tracking area code, if available, and otherwise to the physical cell identity and carrier frequency of the target PCell of the failed handover;
2> include nrPreviousCell in previousPCellId and set it to the global cell identity and tracking area code of the PCell where the last MobilityFromNRCommand message was received;
2> set the timeConnFailure to the elapsed time since the initialization of the handover associated to the last MobilityFromNRCommand message;
1> else if the failure is detected due to radio link failure, set the fields in VarRLF-report as follows:
2> set the connectionFailureType to rlf.
2> set the rlf-Cause to the trigger for detecting radio link failure;
2> set the nr FailedPCellId in failedPCellId to the global cell identity and the tracking area code, if available, and otherwise to the physical cell identity and carrier frequency of the PCell where radio link failure is detected;
2> if an RRCReconfiguration message including the reconfigurationWithSync was received before the connection failure:
3> if the last executed RRCReconfiguration message including the reconfigurationWithSync concerned an intra NR handover and it was received while connected to the previous PCell to which the UE was connected before connecting to the PCell where radio link failure is detected; and
3> if the PCell in which the radio link failure was detected was a result of cell selection and the T311 was not running at the time of PCell selection:
4> include the nrPreviousCell in previousPCellId and set it to the global cell identity and the tracking area code of the PCell where the last executed RRCReconfiguration message including reconfigurationWithSync was received;
4> f the last executed RRCReconfiguration message including

reconfigurationWithSync was concerning a DAPS handover;
5> set lastHO-Type to daps;
4> else if the last executed RRCReconfiguration message including reconfigurationWithSync was concerning a conditional handover;
5> set lastHO-Type to cho;
4> set the timeConnFailure to the elapsed time since the execution of the last RRCReconfiguration message including the reconfiguration WithSync;
3> else if the last RRCReconfiguration message including the reconfigurationWithSync concerned a handover to NR from E-UTRA and if the UE supports Radio Link Failure Report for Inter-RAT MRO EUTRA:
4> include the eutraPreviousCell in previousPCellId and set it to the global cell identity and the tracking area code of the E-UTRA PCell where the last RRCReconfiguration message including reconfigurationWithSync was received embedded in E-UTRA RRC message MobilityFromEUTRACommand message;
4> set the timeConnFailure to the elapsed time since reception of the last RRCReconfiguration message including the reconfigurationWithSync embedded in E-UTRA RRC message MobilityFromEUTRACommand message;
2> if configuration of the conditional handover is available in the MCG VarConditionalReconfig at the moment of declaring the radio link failure:
3> set timeSinceCHO-Reconfig to the time elapsed between the detection of the radio link failure, and the reception, in the source PCell, of the last conditionalReconfiguration including the condRRCReconfig message;
3> set choCandidateCellList to include the global cell identity if available, and otherwise to the physical cell identity and carrier frequency of each of all the candidate target cells for conditional handover included in condRRCReconfig within the MCG VarConditionalReconfig at the time of radio link failure, excluding the candidate target cells included in measResulNeighCells;
1> if connectionFailureType is rlf and the rlf-Cause is set to randomAccessProblem or beamFailureRecoveryFailure; or
1> if connectionFailureType is hof and if the failed handover is an intra-RAT handover:
2> set the ra-InformationCommon to include the random-access related information;
1> if available, set the locationInfo.

The UE may discard the radio link failure information or handover failure information, i.e. release the UE variable VarRLF-Report, 48 hours after the radio link failure/handover failure is detected.

Hereinafter, RRC re-establishment (or, RRC connection re-establishment) procedure is described.

The purpose of the RRC re-establishment procedure is to re-establish the RRC connection. A UE in RRC_CONNECTED, for which AS security has been activated with SRB2 and at least one DRB setup or, for IAB, SRB2, may initiate the procedure in order to continue the RRC connection. The connection re-establishment succeeds if the network is able to find and verify a valid UE context or, if the UE context cannot be retrieved, and the network responds with an RRCSetup.

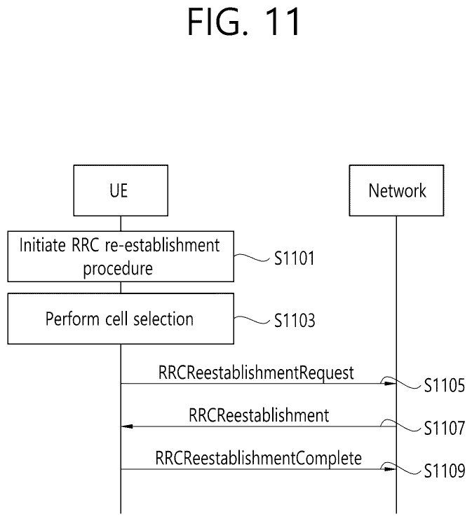

FIG. 11 shows an example of an RRC re-establishment procedure according to an embodiment of the present disclosure.

Referring to FIG. 11, in step S1101, the UE may initiate the RRC re-establishment procedure. The UE initiates the procedure when one of the following conditions is met:
1> upon detecting radio link failure of the MCG and t316 is not configured; or
1> upon detecting radio link failure of the MCG while SCG transmission is suspended; or
1> upon detecting radio link failure of the MCG while PSCell change or PSCell addition is ongoing; or
1> upon re-configuration with sync failure of the MCG; or
1> upon mobility from NR failure; or
1> upon integrity check failure indication from lower layers concerning SRB1 or SRB2, except if the integrity check failure is detected on the RRCReestablishment message; or
1> upon an RRC connection reconfiguration failure; or
1> upon detecting radio link failure for the SCG while MCG transmission is suspended in NR-DC or in NE-DC; or
1> upon reconfiguration with sync failure of the SCG while MCG transmission is suspended; or
1> upon SCG change failure while MCG transmission is suspended; or
1> upon SCG configuration failure while MCG transmission is suspended in NR-DC or in NE-DC; or
1> upon integrity check failure indication from SCG lower layers concerning SRB3 while MCG is suspended; or
1> upon T316 expiry.

In step S1103, upon initiation of the RRC re-establishment procedure, the UE may perform cell selection. The UE may try to select a suitable cell e.g., suitable NR cell.

In step S1105, after selecting a suitable NR cell, the UE may transmit RRCReestablishmentRequest message to a network.

In step S1107, if the network is able to find and verify a valid UE context, the UE may receive RRCReestablishment message from the network.

In step S1109, upon/after receiving the RRCReestablishment message, the UE may transmit RRCReestablishmentComplete message to the network. The UE shall:
1> set the content of RRCReestablishmentComplete message (or, UE-MeasurementsAvailable in the RRCReestablishmentComplete message) as follows:
2> if the UE has logged measurements available for NR and if the RPLMN is included in plmn-IdentityList stored in VarLogMeasReport:
3> include the logMeasAvailable in the RRCReestablishmentComplete message;
3> if Bluetooth measurement results are included in the logged measurements the UE has available for NR:
4> include the logMeasAvailableBT in the RRCReestablishmentComplete message;
3> if WLAN measurement results are included in the logged measurements the UE has available for NR:
4> include the logMeasAvailableWLAN in the RRCReestablishmentComplete message;
2> if the UE has connection establishment failure or connection resume failure information available in VarConnEstFailReport and if the RPLMN is equal to plmn-Identity stored in VarConnEstFailReport:
3> include connEstFailInfoAvailable in the RRCReestablishmentComplete message;
2> if the UE has radio link failure or handover failure information available in VarRLF-Report and if the RPLMN is included in plmn-IdentityList stored in VarRLF-Report; or
2> if the UE has radio link failure or handover failure information available in VarRLF-Report and if the UE is capable of cross-RAT RLF reporting and if the RPLMN is included in plmn-IdentityList stored in VarRLF-Report:
3> include rlf-InfoAvailable in the RRCReestablishmentComplete message.

For example, UE-MeasurementsAvailable in the RRCReestablishmentComplete message comprises information elements (IEs) as shown in table 7:

TABLE 7

UE-Measurements Available-r16 ::= SEQUENCE { logMeasAvailable-r16
ENUMERATED {true} OPTIONAL, logMeasAvailableBT-r16
ENUMERATED {true} OPTIONAL, logMeasAvailableWLAN-r16
ENUMERATED {true} OPTIONAL, connEstFailInfoAvailable-r16
ENUMERATED {true} OPTIONAL, rlf-InfoAvailable-r16
ENUMERATED {true} OPTIONAL, ...}

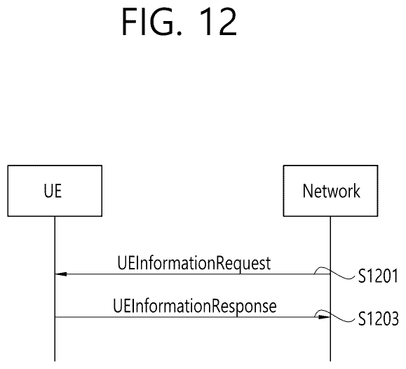

The UE-MeasurementsAvailable may inform to the network that UE information is available at the UE. When the network receives UE-MeasurementsAvailable, the network may initiate a UE information procedure to retrieve the UE information from the UE. FIG. 12 shows an example of a UE information procedure according to an embodiment of the present disclosure. The UE information procedure is used by the network to request the UE to report information (e.g., UE information).

Referring to FIG. 12, in step S1201, the network may initiate the UE information procedure by sending the UEInformationRequest message to the UE. The network should initiate this procedure only after successful security activation.

In step S1203, the UE may transmit UEInformationResponse message to the network. Upon receiving the UEInformationRequest message, the UE shall, only after successful security activation:
1> if the idleModeMeasurementReq is included in the UEInformationRequest and the UE has stored VarMeasIdleReport that contains measurement information concerning cells other than the PCell:
2> set the measResultIdleEUTRA in the UEInformationResponse message to the value of measReportIdleEUTRA in the VarMeasIdleReport, if available;
2> set the measResultIdleNR in the UEInformationResponse message to the value of meas ReportIdleNR in the VarMeasIdleReport, if available;
2> discard the VarMeasIdleReport upon successful delivery of the UEInformationResponse message confirmed by lower layers;
1> if the logMeasReportReq is present and if the RPLMN is included in plmn-IdentityList stored in Var LogMeas Report:
2> if VarLogMeasReport includes one or more logged measurement entries, set the contents of the logMeas Report in the UEInformationResponse message as follows:
3> include the absoluteTimeStamp and set it to the value of absoluteTimeInfo in the VarLogMeasReport;
3> include the traceReference and set it to the value of traceReference in the VarLogMeasReport;
3> include the traceRecordingSessionRef and set it to the value of traceRecordingSessionRef in the VarLogMeasReport;
3> include the tce-Id and set it to the value of tce-Id in the VarLogMeasReport;
3> include the logMeasInfoList and set it to include one or more entries from the VarLogMeasReport starting from the entries logged first, and for each entry of the logMeasInfoList that is included, include all information stored in the corresponding logMeasInfoList entry in VarLogMeasReport;
3> if the VarLogMeasReport includes one or more additional logged measurement entries that are not included in the logMeasInfoList within the UEInformationResponse message:
4> include the logMeasAvailable;
4> if bt-LocationInfo is included in locationInfo of one or more of the additional logged measurement entries in VarLogMeas Report that are not included in the logMeasInfoList within the UEInformationResponse message:
5> include the logMeasAvailableBT;
4> if wlan-LocationInfo is included in locationInfo of one or more of the additional logged measurement entries in VarLogMeasReport that are not included in the logMeasInfoList within the UEInformationResponse message:
5> include the logMeasAvailableWLAN;
1> if ra-ReportReq is set to true and the UE has random access related information available in VarRA-Report and if the RPLMN is included in plmn-IdentityList stored in VarRA-Report;
2> set the ra-ReportList in the UEInformationResponse message to the value of ra-ReportList in VarRA-Report;
2> discard the ra-ReportList from VarRA-Report upon successful delivery of the UEInformationResponse message confirmed by lower layers;
1> if rlf-ReportReq is set to true:
2> if the UE has radio link failure information or handover failure information available in VarRLF-Report and if the RPLMN is included in plmn-IdentityList stored in VarRLF-Report:
3> set timeSinceFailure in VarRLF-Report to the time that elapsed since the last radio link failure or handover failure in NR;
3> set the rlf-Report in the UEInformationResponse message to the value of rlf-Report in VarRLF-Report;
3> discard the rlf-Report from VarRLF-Report upon successful delivery of the UEInformationResponse message confirmed by lower layers;
2> else if the UE is capable of cross-RAT RLF reporting and has radio link failure information or handover failure information available in VarRLF-Report and if the RPLMN is included in plmn-IdentityList stored in VarRLF-Report:
3> set timeSinceFailure in VarRLF-Report to the time that elapsed since the last radio link failure or handover failure in EUTRA;
3> set failedPCellId-EUTRA in the rlf-Report in the UEInformationResponse message to indicate the PCell in which RLF was detected or the source PCell of the failed handover in the VarRLF-Report;
3> set the measResult-RLF-Report-EUTRA in the rlf-Report in the UEInformationResponse message to the value of rlf-Report in VarRLF-Report;
3> discard the rlf-Report from VarRLF-Report upon successful delivery of the UEInformationResponse message confirmed by lower layers;
1> if connEstFailReportReq is set to true and the UE has connection establishment failure or connection resume failure information in VarConnEstFailReport and if the RPLMN is equal to plmn-Identity stored in VarConnEstFailReport;
2> set timeSinceFailure in VarConnEstFailReport to the time that elapsed since the last connection establishment failure or connection resume failure in NR;
2> set the connEstFailReport in the UEInformationResponse message to the value of connEstFailReport in VarConnEstFailReport;
2> discard the connEstFailReport from VarConnEstFailReport upon successful delivery of the UEInformationResponse message confirmed by lower layers;
1> if the mobilityHistoryReportReq is set to true:
2> include the mobilityHistoryReport and set it to include entries from VarMobilityHistoryReport;
2> include in the mobilityHistoryReport an entry for the current cell, possibly after removing the oldest entry if required, and set its fields as follows:
3> set visitedCellId to the global cell identity or the physical cell identity and carrier frequency of the current cell:
3> set field timeSpent to the time spent in the current cell;
1> if the logMeasReport is included in the UEInformationResponse:
2> submit the UEInformationResponse message to lower layers for transmission via SRB2;
2> discard the logged measurement entries included in the logMeasInfoList from VarLogMeasReport upon successful delivery of the UEInformationResponse message confirmed by lower layers;
1> else:
2> submit the UEInformationResponse message to lower layers for transmission via SRB1.

Meanwhile, Self-Organising Networks (SON), which encompasses solutions for network self-configuration and self-optimisation, was introduced to support deployment of the system and performance optimization. There are various SON features such as PCI allocation, Automatic Neighbour Relations (ANR), Mobility Robustness Optimisation (MRO), Mobility Load Balancing (MLB) and RACH optimisation.

In order for the network (NW) to collect data for SON, the UE stores the failure related information into a SON related report (e.g., VarRLF-report and/or RLF-report in VarRLF-report) when the UE detects a connection failure such as radio link failure (RLF) and handover failure (HOF). After re-establishing with NW, the UE transmits the connection complete message (e.g. RRC ReconfigurationComplete, RRCResumeComplete, RRCSetupComplete, etc.) with the indication representing the existence of SON related report (e.g. rlf-InfoAvailable) to NW. Then, NW initiates the UE information procedure with transmitting the request message such as UEInformationRequest including the indicator representing the request of the SON related report to the UE. Finally, the UE delivers the UEInformationResponse including the SON related report. After transmitting the SON related report, the UE discards the whole contents of the SON related report in its storage. In the current UE information procedure, there is a single indicator for UE or NW representing the UE has the report to deliver or the NW has the request of the report to the UE.

As various new features such as dual-connectivity and conditional mobility are standardized, information elements (IEs) for SON of new features may be added to the existing SON related report. For example, the conditional handover (CHO) failure related IEs will be added as additional IEs to the existing RLF-Report in the 3GPP NR/LTE standard Release 17 (or, simply release 17 as a version of radio protocol), which means that a single report may include different versions of IEs, as shown in table 8:

TABLE 8

RLF-Report-r16 ::= CHOICE { nr-RLF-Report-r16
SEQUENCE { measResultLastServCell-r16 MeasResultRLFNR-r16,
measResultNeighCells-r16 SEQUENCE { measResultListNR-r16
MeasResultList2NR-r16 OPTIONAL, measResultListEUTRA-r16
MeasResultList2EUTRA-r16 OPTIONAL }
OPTIONAL, c-RNTI-r16 RNTI-Value,
previousPCellId-r16 CHOICE { nrPreviousCell-r16
CGI-Info-Logging-r16, eutraPreviousCell-r16 CGI-
InfoEUTRALogging }
OPTIONAL, failedPCellId-r16 CHOICE
{ nrFailedPCellId-r16 CHOICE
{ cellGlobalId-r16 CGI-Info-Logging-r16,
pci-arfcn-r16 PCI-ARFCN-NR-r16 },
eutraFailedPCellId-r16 CHOICE { cellGlobalId-r16
CGI-InfoEUTRALogging, pci-arfcn-r16 PCI-
ARFCN-EUTRA-r16 } }, reconnectCellId-r16
CHOICE { nrReconnectCellId-r16 CGI-Info-Logging-r16,
eutraReconnectCellId-r16 CGI-InfoEUTRALogging }
OPTIONAL, timeUntilReconnection-r16 TimeUntilReconnection-r16
OPTIONAL, reestablishmentCellId-r16 CGI-Info-Logging-r16
OPTIONAL, timeConnFailure-r16 INTEGER (0..1023)
OPTIONAL, timeSinceFailure-r16 TimeSinceFailure-r16,
connectionFailureType-r16 ENUMERATED {rlf, hof}, rlf-Cause-r16
ENUMERATED {t310-Expiry, randomAccessProblem, rlc-MaxNumRetx,
beamFailureRecovery Failure, lbtFailure-r16,
bh-rlfRecoveryFailure, t312-expiry-r17, spare1}, locationInfo-r16
LocationInfo-r16 OPTIONAL,
noSuitableCellFound-r16 ENUMERATED {true}
OPTIONAL, ra-InformationCommon-r16 RA-InformationCommon-
r16 OPTIONAL, ..., [[ csi-
rsRLMConfigBitmap-v1650 BIT STRING (SIZE (96))
OPTIONAL ]], [[ lastHO-Type-r17
ENUMERATED {cho, daps, spare2, spare1} OPTIONAL,
timeConnSourceDAPS-Failure-r17 TimeConnSourceDAPS-Failure-r17
OPTIONAL, timeSinceCHO-Reconfig-r17 TimeSinceCHO-Reconfig-
r17 OPTIONAL, choCellId-r17
CHOICE { cellGlobalId-r17 CGI-Info-Logging-r16,
pci-arfcn-r17 PCI-ARFCN-NR-r16 }
OPTIONAL, choCandidateCellList-r17 ChoCandidateCellList-r17
OPTIONAL ]] }, eutra-RLF-Report-r16 SEQUENCE
{ failedPCellId-EUTRA CGI-InfoEUTRALogging,
measResult-RLF-Report-EUTRA-r16 OCTET STRING, ...,
[[ measResult-RLF-Report-EUTRA-v1690 OCTET STRING
OPTIONAL ]] }}

In table 8, IEs having a notation “r17” represents that a version of radio protocol supporting these IEs is equal to or later than 3GPP NR/LTE standard release 17 (or, simply release 17). IEs having a notation “r16” represents that a version of radio protocol supporting these IEs is equal to or later than 3GPP NR/LTE standard release 16 (or, simply release 16). If certain information consists of IEs having a notation “r17”, a version of radio protocol related to the information is release 17. For example, conditional mobility failure information may consist of IEs having a notation “r17” such as lastHO-Type, timeSinceCHO-Reconfig, choCellId and/or choCandidateCellList—therefore, a version of radio protocol related to the conditional mobility failure information is release 17. Herein, lastHO-Type is used to indicate the type of the last executed handover before the last detected connection failure, and set to cho if the last executed handover was initiated by a conditional reconfiguration execution. timeSinceCHO-Reconfig is used to indicate the time elapsed between the initiation of the last conditional reconfiguration execution towards the target cell and the reception of the latest conditional reconfiguration, or the time elapsed between the radio link failure and the reception of the latest conditional reconfiguration while connected to the source PCell. choCandidateCellList is used to indicate the list of candidate target cells for conditional handover included in condRRCReconfig at the time of connection failure, choCellId is used to indicate the candidate target cell for conditional handover included in condRRCReconfig that the UE selected for CHO based recovery while T311 is running. In the present disclosure, IEs having a latest/new version of radio protocol are referred to as existing/legacy IEs, and IEs having a version of radio protocol earlier than the latest version (i.e., legacy/existing version) are referred to as new/additional IEs. Further, the existing IEs and the new additional IEs in the report are called first information and second information, respectively. It is assumed in the present disclosure that the latest version of radio protocol is release 17. Therefore, the second information may comprise the conditional mobility failure information.

When the UE transmits the single report including both first and second information to a legacy eNB/gNB that cannot interpret the second information (i.e., eNB/gNB that does not support the latest version), the second information can be lost. Due to the limitation of interpretation capability of eNB/gNB, the second information is lost and consequently the second information is not used for SON. This kind of behaviour is undesirable in terms of SON objectives.

In the present disclosure, if UE detects a connection failure (e.g., RLF and/or mobility failure), the UE may store failure related information in a report (e.g., failure report). Depending on the UE's capabilities, the UE may store different information.

For example, the UE may store only the first information in the report if the UE is capable of storing only the first information (e.g., if the UE does not support the latest version but supports the legacy version).

For example, the UE may store only the second information in the report if the UE is capable of storing the second information (e.g., if the UE supports the latest version).

For example, the UE may store both the first and the second information in the report if the UE is capable of storing the second information (e.g., if the UE supports the latest version).

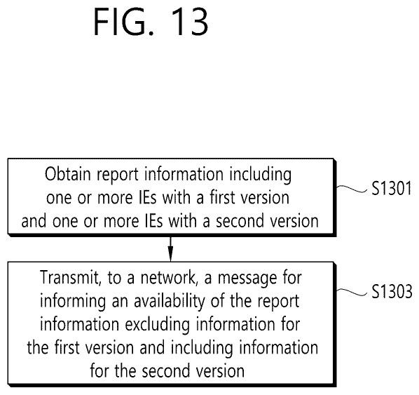

FIG. 13 shows an example of a method performed by a UE according to an embodiment of the present disclosure. The method may also be performed by a UE.

Referring to FIG. 13, in step S1301, the UE may obtain report information including one or more information elements (IEs) with a first version and one or more IEs with a second version. The first version is an earlier version than the second version, and the second version is a latest version of radio protocol.

In step S1303, the UE may transmit, to a network, a message for informing an availability of the report information. The message may exclude information for the first version, and include information for the second version.

According to various embodiments, the UE may detect a failure. The UE may store failure information related to the failure in the report information. The failure information may comprise at least one of the one or more IEs with the first version or the one or more IEs with the second version.

According to various embodiments, the failure may comprise a radio link failure (RLF). The failure information may comprise RLF information related to the RLF. The RLF information may comprise the one or more IEs with the first version.

According to various embodiments, the failure may comprise a conditional mobility failure. The failure information may comprise conditional mobility failure information related to the conditional mobility failure. The conditional mobility failure information may comprise the one or more IEs with the second version.

According to various embodiments, the UE may perform a connection procedure to the network after detecting the failure. The UE may transmit, to the network, a connection complete message after the UE connects to the network based on the connection procedure. The connection complete message may comprise the message for informing an availability of the report information.

According to various embodiments, the connection procedure may comprise at least one of a radio resource control (RRC) establishment procedure, an RRC re-establishment procedure. RRC resume procedure. RRC reconfiguration procedure or a mobility procedure. The connection complete message may comprise at least one of an RRC setup complete message related to the RRC establishment procedure, an RRC re-establishment complete message related to the RRC re-establishment procedure, an RRC resume complete message related to the RRC resume procedure, an RRC reconfiguration complete message related to the RRC reconfiguration procedure, or a mobility complete message related to the mobility procedure.

According to various embodiments, the information for the first version may inform that the report information including the one or more IEs with the first version is available. The information for the second version may inform that the report information including the one or more IEs with the second version is available.

According to various embodiments, the information for the first version may comprise rlf-InfoAvailable with the first version. The information for the second version may comprise rlf-InfoAvailable with the second version.

According to various embodiments, after transmitting the message for informing an availability of the report information, the UE may receive, from the network, a message for requesting the report information and transmit, to the network, a message including one or more IEs in the report information.

According to various embodiments, the message for requesting the report information may be received from the network based on the second version being supported by the network.

According to various embodiments, the message for requesting the report information may comprise a UE information request message. The message including one or more IEs in the report information may comprise a UE information response message.

According to various embodiments, after transmitting the message including one or more IEs in the report information, the UE may discard whole contents of the report information.

Furthermore, the method in perspective of the UE described above in FIG. 13 may be performed by first wireless device 100 shown in FIG. 2, the wireless device 100 shown in FIG. 3, the first wireless device 100 shown in FIG. 4 and/or the UE 100 shown in FIG. 5.

More specifically, the UE comprises at least one transceiver, at least processor, and at least one computer memory operably connectable to the at least one processor and storing instructions that, based on being executed by the at least one processor, perform operations.

The operations comprise: obtaining report information including one or more information elements (IEs) with a first version and one or more IEs with a second version, wherein the first version is an earlier version than the second version, and the second version is a latest version of radio protocol; and transmitting, to a network, a message for informing an availability of the report information, wherein the message excludes information for the first version, and includes information for the second version.

Furthermore, the method in perspective of the UE described above in FIG. 13 may be performed by a software code 105 stored in the memory 104 included in the first wireless device 100 shown in FIG. 4.

More specifically, at least one computer readable medium (CRM) stores instructions that, based on being executed by at least one processor, perform operations comprising: obtaining report information including one or more information elements (IEs) with a first version and one or more IEs with a second version, wherein the first version is an earlier version than the second version, and the second version is a latest version of radio protocol; and transmitting, to a network, a message for informing an availability of the report information, wherein the message excludes information for the first version, and includes information for the second version.

Furthermore, the method in perspective of the UE described above in FIG. 13 may be performed by control of the processor 102 included in the first wireless device 100 shown in FIG. 2, by control of the communication unit 110 and/or the control unit 120 included in the wireless device 100 shown in FIG. 3, by control of the processor 102 included in the first wireless device 100 shown in FIG. 4 and/or by control of the processor 102 included in the UE 100 shown in FIG. 5.

More specifically, an apparatus configured to/adapted to operate in a wireless communication system (e.g., wireless device/UE) comprises at least processor, and at least one computer memory operably connectable to the at least one processor. The at least one processor is configured to/adapted to perform operations comprising: obtaining report information including one or more information elements (IEs) with a first version and one or more IEs with a second version, wherein the first version is an earlier version than the second version, and the second version is a latest version of radio protocol; and transmitting, to a network, a message for informing an availability of the report information, wherein the message excludes information for the first version, and includes information for the second version.

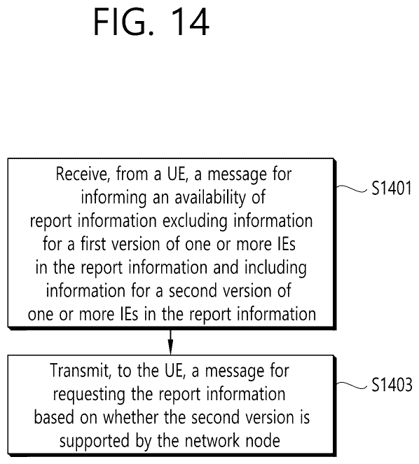

FIG. 14 shows an example of a method performed by a network node according to an embodiment of the present disclosure. The network node may comprise BS.

Referring to FIG. 14, in step S1401, the network node may receive, from a UE, a message for informing an availability of report information. The message may exclude information for a first version of one or more information elements (IEs) in the report information and include information for a second version of one or more IEs in the report information. The first version is an earlier version than the second version, and the second version is a latest version of radio protocol.

In step S1403, the network node may transmit, to the UE, a message for requesting the report information based on whether the second version is supported by the network node.

Furthermore, the method in perspective of the network node described above may be performed by second wireless device 100 shown in FIG. 2, the device 100 shown in FIG. 3. and/or the second wireless device 200 shown in FIG. 4.

More specifically, the network node comprises at least one transceiver, at least processor, and at least one computer memory operably connectable to the at least one processor and storing instructions that, based on being executed by the at least one processor, perform operations.

The operations comprise: receiving, from a user equipment (UE), a message for informing an availability of report information, wherein the message excludes information for a first version of one or more information elements (IEs) in the report information and includes information for a second version of one or more IEs in the report information, and wherein the first version is an earlier version than the second version, and the second version is a latest version of radio protocol; and transmitting, to the UE, a message for requesting the report information based on whether the second version is supported by the network node.

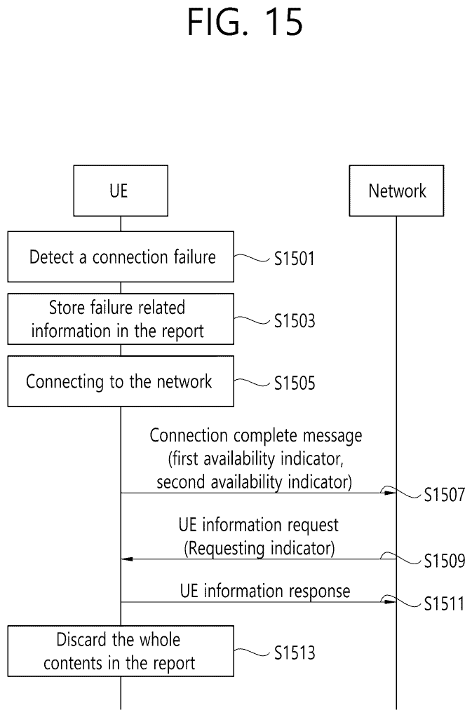

FIG. 15 shows an example of a procedure for signalling an availability indicator according to an embodiment of the present disclosure. In FIG. 15, separate indicators for availability of the first and second information are used in the connection complete message of the UE.

Referring to FIG. 15, in step S1501, the UE may detect a connection failure (e.g., mobility failure/RLF).

In step S1503, if the UE detects the connection failure, the UE may store failure related information (e.g., mobility failure information, RLF information) in the report (e.g., rlf-report and/or VarRLF-report).

In step S1505, the UE may connect to the network. The UE may perform RRC establishment procedure, RRC re-establishment procedure, RRC resume procedure, RRC reconfiguration procedure or handover procedure.

In step S1507, after the UE connects to the network (e.g., eNB or gNB), the UE may transmit a connection complete message (e.g., RRCSetupComplete, RRCReestbalsihmentComplete, RRCResumeComplete, RRCReconfigurationComplete and/or mobility complete message) to the network.

For example, if the UE stores only the first information (i.e., one or more IEs with legacy version) in the report, the UE may transmit the connection complete message with the first availability indicator (i.e., information for the legacy version, rlf-InfoAvailable-r16) representing the UE has the report including the first information.

For example, if the UE stores only the second information (i.e., one or more IEs with latest version) in the report, the UE may transmit the connection complete message with the second availability indicator (i.e., information for the latest version, rlf-InfoAvailable-r17) representing the UE has the report including the second information.

For example, if the UE stores both the first and the second information in the report, the UE may transmit the connection complete message with the second availability indicator representing the UE has the report including both the first and the second information.

For example, if the UE stores nothing in the report, the UE may transmit the connection complete message without the first and the second availability indicators.

In step S1509, after the network receives the connection complete message from the UE, the network may initiate UE information procedure with transmitting a request message (e.g., UEInformationRequest) to the UE.

For example, if the network is capable of interpreting both the first and the second information, the network may initiate the UE information procedure with transmitting the request message (e.g. UEInformationRequest) including the requesting indicator (e.g., rlf-ReportReq set to true) if the connection complete message includes either the first or the second availability indicators. Otherwise the network may not trigger the UE information procedure, or the network may trigger the UE information procedure indicating that no response is needed.

For example, if the network is capable of interpreting only the first information, the network may initiate the UE information procedure with transmitting the request message (e.g. UEInformationRequest) including the requesting indicator to the UE if the connection complete message includes the first availability indicator. Otherwise the network may not trigger the UE information procedure or the network may trigger the UE information procedure indicating that no response is needed.

In step S1511, If the UE receives the request message including the requesting indicator from the network, the UE responds with a message (e.g. UEInformationResponse) including the report.

In step S1513, after transmitting the report, the UE may discard the whole contents of the report in its storage.

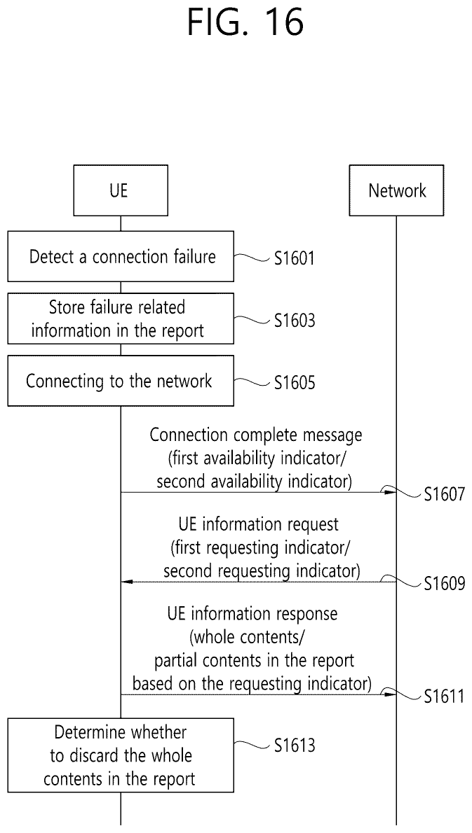

FIG. 16 shows an example of a procedure for signalling an availability indicator and one or more requesting indicators according to an embodiment of the present disclosure. In FIG. 16, separate indicators for availability of the first and second information are used in the connection complete message of the UE, and one or more indicators representing the interpretation capability of eNB/gNB are used in the request message of the eNB/gNB.

Referring to FIG. 16, in step S1601, the UE may detect a connection failure (e.g., mobility failure/RLF).

In step S1603, if the UE detects the connection failure, the UE may store failure related information (e.g., mobility failure information, RLF information) in the report (e.g., rlf-report and/or VarRLF-report).

In step S1605, the UE may connect to the network. The UE may perform RRC establishment procedure, RRC re-establishment procedure, RRC resume procedure, RRC reconfiguration procedure or handover procedure.

In step S1607, after the UE connects to the network (e.g., eNB or gNB), the UE may transmit a connection complete message (e.g., RRCSetupComplete, RRC ReestbalsihmentComplete, RRCResumeComplete, RRCReconfigurationComplete and/or mobility complete message) to the network.

For example, if the UE stores only the first information (i.e., one or more IEs with legacy version) in the report, the UE may transmit the connection complete message with the first availability indicator (i.e., information for the legacy version, rlf-InfoAvailable-r16) representing the UE has the report including the first information.

For example, if the UE stores only the second information (i.e., one or more IEs with latest version) in the report, the UE may transmit the connection complete message with the second availability indicator (i.e., information for the latest version, rlf-InfoAvailable-r17) representing the UE has the report including the second information.

For example, if the UE stores both the first and the second information in the report, the UE may transmit the connection complete message with the second availability indicator representing the UE has the report including both the first and the second information.

For example, if the UE stores nothing in the report, the UE may transmit the connection complete message without the first and the second availability indicators.

In step S1609, after the network receives the connection complete message from the UE, the network may initiate UE information procedure with transmitting a request message (e.g., UEInformationRequest) to the UE.

For example, if the network is capable of interpreting both the first and the second information and the connection complete message includes either/both the first or/and the second availability indicators, the network may initiate the UE information procedure with transmitting the request message (e.g. UEInformationRequest) including both the first and the second requesting indicators to the UE.

For example, if the network is capable of interpreting only the first information and the connection complete message includes the first availability indicator, the network may initiate the UE information procedure with transmitting the request message (e.g. UEInformationRequest) including the first requesting indicator to the UE if the connection complete message includes the first availability indicator.

For example, if the network is capable of interpreting only the first information and the connection complete message includes the second availability indicator, the network may not trigger the UE information procedure (i.e., the network does not interpret the second availability indicator in the connection complete message).

In step S1611, If the UE receives the request message including the requesting indicator from the network, the UE responds with a message (e.g. UEInformationResponse) including the report. The UE response message may contain the whole contents or the partial contents in the report based on the requesting indicator.

In step S1613, after transmitting the report, the UE may determine whether to discard the whole contents of the report in its storage.

For example, if the request message includes only the first requesting indicator and the report includes both the first and the second information, the UE may i) keep the whole contents of the report in its storage, and/or ii) discard the contents corresponding to the first information of the report in its storage. The remaining contents (i.e., second information) may contain the indicator associating with the discarded contents (i.e. first information).

For example, if the request message includes only the first requesting indicator and the report includes only the first information, the UE may discard the whole contents of the report in its storage.

For example. if the request message includes both the first and the second requesting indicators, the UE may discard the whole contents of the report in its storage.

According to various embodiments, the UE may detect a connection failure from a network. The UE may store information related to the connection failure. The stored information may comprise a first information and a second information. The UE may transmit information indicating that information related to connection failure are available to the network. The first availability indicator may stand for storing the first information and the second availability information indicator may stand for storing the second information. The UE may receive a request to report the information related to connection failure from the network. The request may comprise a first and a second requesting indicator. The UE may select a subset of stored information to report, based on the indicator included in the request. The first information may be selected if the first requesting indicator is included. The first information and the second information may be selected if the second requesting indicator is included. The UE may transmit the selected information to the network. The UE may keep the whole information if the second information is not delivered.

According to various embodiments, the UE may detect a connection failure from a network. The UE may store information related to the connection failure. The stored information may comprise a first information and a second information. The UE may transmit information indicating that information related to connection failure are available to the network. The first availability indicator may stand for storing the first information and the second availability information indicator may stand for storing the second information. The UE may receive a request to report the information related to connection failure from the network. The request may comprise a first and a second requesting indicator. The UE may select a subset of stored information to report, based on the indicator included in the request. The first information may be selected if the first requesting indicator is included, and the first information and the second information may be selected if the second requesting indicator is included. The UE may transmit the selected information to the network. The UE may discard the selected information while keeping other information not selected from the stored information.

For the simplicity, it is assumed in the proposed methods that two indicators (or information) are signalled. However, the proposed methods are also applicable to cases where more than two indicators are signalled. For instance, there may be three available indictors indicated by UE to differentiate three different versions of information to report, or three reporting request indicators indicated by NW to differentiate three different version of information to retrieve.

The present disclosure can have various advantageous effects.

For example, the reporting data loss problem incurred by the limitation of interpretation capability of NW (e.g. eNB, gNB, etc.) can be prevented. In doing so, NW can collect data from UEs for SON without data loss, which results in mobility robustness optimization (MRO) and/or mobility load balancing (MLB) enhancements.

Advantageous effects which can be obtained through specific embodiments of the present disclosure are not limited to the advantageous effects listed above. For example, there may be a variety of technical effects that a person having ordinary skill in the related art can understand and/or derive from the present disclosure. Accordingly, the specific effects of the present disclosure are not limited to those explicitly described herein, but may include various effects that may be understood or derived from the technical features of the present disclosure.

Claims in the present disclosure can be combined in a various way. For instance, technical features in method claims of the present disclosure can be combined to be implemented or performed in an apparatus, and technical features in apparatus claims can be combined to be implemented or performed in a method. Further, technical features in method claim(s) and apparatus claim(s) can be combined to be implemented or performed in an apparatus. Further, technical features in method claim(s) and apparatus claim(s) can be combined to be implemented or performed in a method. Other implementations are within the scope of the following claims.

1. A method performed by a user equipment (UE) in a wireless communication system, the method comprising:
obtaining report information including one or more information elements (IEs) with a first version and one or more IEs with a second version, wherein the first version is an earlier version than the second version, and the second version is a latest version of radio protocol; and
transmitting, to a network, a message for informing an availability of the report information,
wherein the message excludes information for the first version, and includes information for the second version.

2. The method of claim 1, further comprising:
detecting a failure; and
storing failure information related to the failure in the report information,
wherein the failure information comprises at least one of the one or more IEs with the first version or the one or more IEs with the second version.

3. The method of claim 2, wherein the failure comprises a radio link failure (RLF),
wherein the failure information comprises RLF information related to the RLF, and
wherein the RLF information comprises the one or more IEs with the first version.

4. The method of claim 2, wherein the failure comprises a conditional mobility failure,
wherein the failure information comprises conditional mobility failure information related to the conditional mobility failure, and
wherein the conditional mobility failure information comprises the one or more IEs with the second version.

5. The method of claim 2, further comprising:
performing a connection procedure to the network after detecting the failure; and
transmitting, to the network, a connection complete message after the UE connects to the network based on the connection procedure,
wherein the connection complete message comprises the message for informing an availability of the report information.

6. The method of claim 5, wherein the connection procedure comprises at least one of a radio resource control (RRC) establishment procedure, an RRC re-establishment procedure, RRC resume procedure, RRC reconfiguration procedure or a mobility procedure, and
wherein the connection complete message comprises at least one of an RRC setup complete message related to the RRC establishment procedure, an RRC re-establishment complete message related to the RRC re-establishment procedure, an RRC resume complete message related to the RRC resume procedure, an RRC reconfiguration complete message related to the RRC reconfiguration procedure, or a mobility complete message related to the mobility procedure.

7. The method of claim 1, wherein the information for the first version informs that the report information including the one or more IEs with the first version is available, and
wherein the information for the second version informs that the report information including the one or more IEs with the second version is available.

8. The method of claim 1, wherein the information for the first version comprises rlf-InfoAvailable with the first version, and
Wherein the information for the second version comprises rlf-InfoAvailable with the second version.

9. The method of claim 1, after transmitting the message for informing an availability of the report information, further comprising:
receiving, from the network, a message for requesting the report information; and
transmitting, to the network, a message including one or more IEs in the report information.

10. The method of claim 9, wherein the message for requesting the report information is received from the network based on the second version being supported by the network.

11. The method of claim 9, wherein the message for requesting the report information comprises a UE information request message, and
wherein the message including one or more IEs in the report information comprises a UE information response message.

12. The method of claim 9, after transmitting the message including one or more IEs in the report information, further comprising:
discarding whole contents of the report information.

13. The method of claim 1, wherein the UE is in communication with at least one of a mobile device, a network, or autonomous vehicles other than the UE.

14. A user equipment (UE) adapted to operate in a wireless communication system, the UE comprising:
at least one transceiver;
at least processor; and
at least one computer memory operably connectable to the at least one processor and storing instructions that, based on being executed by the at least one processor, perform operations comprising:
obtaining report information including one or more information elements (IEs) with a first version and one or more IEs with a second version, wherein the first version is an earlier version than the second version, and the second version is a latest version of radio protocol; and
transmitting, to a network, a message for informing an availability of the report information,
wherein the message excludes information for the first version, and includes information for the second version.

15. A network node adapted to operate in a wireless communication system, the network node comprising:
at least one transceiver;
at least processor; and
at least one computer memory operably connectable to the at least one processor and storing instructions that, based on being executed by the at least one processor, perform operations comprising:
receiving, from a user equipment (UE), a message for informing an availability of report information, wherein the message excludes information for a first version of one or more information elements (IEs) in the report information and includes information for a second version of one or more IEs in the report information, and wherein the first version is an earlier version than the second version, and the second version is a latest version of radio protocol; and
transmitting, to the UE, a message for requesting the report information based on whether the second version is supported by the network node.

16-18. (canceled)
